(19) United States
(12) Patent Application Publication
(10) Pub. No.: US 2026/0352931 A1
(43) Pub. Date: Nov. 5, 2026

(54) DATA DISTRIBUTION SYSTEM, DATA DISTRIBUTION METHOD, DATA PROCESSING DEVICE, AND DATA PROCESSING METHOD

(71) Applicant: SONY GROUP CORPORATION, TOKYO (JP)

(72) Inventors: TOSHIYA HAMADA, TOKYO (JP); KAZUMOTO KONDO, TOKYO (JP)

(21) Appl. No.: 18/997,543

(22) PCT Filed: Aug. 9, 2023
(86) PCT No.: PCT/JP2023/029160

§ 371 Date: Jan. 22, 2025

(30) Foreign Application Priority Data
Aug. 12, 2022 (JP) 2022-128941

(51) Int. Cl. H04N 21/81; G06T 13/40; G06T 17/20; H04N 21/2187; H04N 21/84

(52) U.S. Cl. CPC H04N 21/816; G06T 13/40; G06T 17/20; H04N 21/2187; H04N 21/84

(57) ABSTRACT

A data distribution system includes: a central server device that generates 3D scene description data that describes a scene in a virtual space that includes 3D models of a plurality of users and changes in real time; and a plurality of edge server devices each communicating with the central server device and being dispersedly arranged at a position geographically separated from each other, and generating distribution data to a corresponding user on the basis of the 3D scene description data generated by the central server device.

### FIELD

The present disclosure relates to a data distribution system, a data distribution method, a data processing device, and a data processing method.

### BACKGROUND

For example, as disclosed in Patent Literature 1 and Patent Literature 2, various techniques related to provision of a virtual space have been proposed.

### CITATION LIST

### Patent Literature

Patent Literature 1: JP 2020-17242 A

Patent Literature 2: JP 2020-21394 A

### SUMMARY

### Technical Problem

For example, it is conceivable to virtualize a large-scale live event venue and distribute the event in real time. In this case, it is necessary to construct a virtual space including a large number of users, which reflects movement of the users, or enables interaction between the users. Since a huge amount of data needs to be transmitted and processed, a delay (motion-to-photon latency) occurs until movement of the user is reflected in the virtual space and displayed in a video and perceived, or a delay occurs in the interaction between the users.

One aspect of the present disclosure suppresses delay.

### Solution to Problem

A data distribution system according to one aspect of the present disclosure includes: a central server device that generates 3D scene description data that describes a scene in a virtual space that includes 3D models of a plurality of users and changes in real time; and a plurality of edge server devices each communicating with the central server device and being dispersedly arranged at a position geographically separated from each other, and generating distribution data to a corresponding user on the basis of the 3D scene description data generated by the central server device.

A data distribution method according to one aspect of the present disclosure includes: generating, by a central server device, 3D scene description data that describes a scene in a virtual space that includes 3D models of a plurality of users and changes in real time; and generating, by each of a plurality of edge server devices, distribution data to a corresponding user on the basis of the 3D scene description data generated by the central server device, each of the plurality of edge server devices communicating with the central server device and being dispersedly arranged at a position geographically separated from each other.

A data processing device according to one aspect of the present disclosure generates distribution data to a corresponding user on the basis of 3D scene description data that describes a scene in a virtual space that includes 3D models of a plurality of users and changes in real time.

A data processing method according to one aspect of the present disclosure includes: generating, by a data processing device, distribution data to a corresponding user on the basis of 3D scene description data that describes a scene in a virtual space that includes 3D models of a plurality of users and changes in real time.

### BRIEF DESCRIPTION OF DRAWINGS

FIG. 1 is a diagram illustrating an example of a schematic configuration of a data distribution system 100 according to an embodiment.

FIG. 2 is a view illustrating an example of bounding box data.

FIG. 3 is a view illustrating an example of 3D model data (avatar data) of a viewer.

FIG. 4 is a diagram illustrating an example of animation data.

FIG. 5 is a diagram illustrating an example of a connection relationship of devices and data transmission between the devices.

FIG. 6 is a diagram illustrating an example of sharing of network resources.

FIG. 7 is a diagram illustrating an example of arrangement of a central server device 3.

FIG. 8 is a diagram illustrating an example of geographical arrangement of an edge server device 2.

FIG. 9 is a diagram illustrating an example of mapping.

FIG. 10 is a diagram illustrating an example of a viewer group.

FIG. 11 is a diagram illustrating an example of a viewer group.

FIG. 12 is a view illustrating an example of interaction between 3D models of viewers Au belonging to different viewer groups.

FIG. 13 is a diagram illustrating an example of operation of the data distribution system 100 at a distribution preparation stage.

FIG. 14 is a diagram illustrating an example of operation of the data distribution system 100 at the distribution preparation stage.

FIG. 15 is a diagram illustrating an example of operation of the data distribution system 100 at a preparation stage immediately before distribution.

FIG. 16 is a diagram illustrating an example of operation of the data distribution system 100 at the preparation stage immediately before distribution.

FIG. 17 is a diagram illustrating an example of operation of the data distribution system 100 in distribution.

FIG. 18 is a diagram illustrating an example of operation of the data distribution system 100 in distribution.

FIG. 19 is a diagram illustrating an example of operation of the data distribution system 100 in distribution.

FIG. 20 is a diagram illustrating an example of operation of the data distribution system 100 in distribution.

FIG. 21 is a diagram illustrating an example of operation of the data distribution system 100 in distribution.

FIG. 22 is a diagram illustrating an example of operation of the data distribution system 100 in distribution.

FIG. 23 is a diagram illustrating a comparative example.

FIG. 24 is a diagram illustrating a comparative example.

FIG. 25 is a diagram illustrating a consideration example.

FIG. 26 is a diagram illustrating an example of network resources.

FIG. 27 is a diagram illustrating an example of a network configuration according to a modification.

FIG. 28 is a diagram illustrating an example of a hardware configuration of a device.

### DESCRIPTION OF EMBODIMENTS

In the following, embodiments of the present disclosure will be described in detail with reference to the drawings. In each of the following embodiments, the same parts are denoted by the same reference numerals to omit redundant description.

The present disclosure will be described according to the following order of items.
0. Introduction
1. Embodiment
2. Modification
3. Example of Hardware Configuration
4. Conclusion

### 0. Introduction

One use case of the disclosed technique is distribution of a live event such as a music live show using a virtualized space. A virtual space including a venue in which virtual selves (3D models to be described later) and the like of users, more specifically, a performer and a viewer, are arranged, is constructed, and scenes thereof, for example, videos and sounds are provided to the users. In a virtual space, not only performance, utterance, body movement, and the like of a performer in a real space are reflected in real time, but also voice, body movement, and the like of a viewer are reflected in real time. For example, a viewer can dance together with other viewer in accordance with a performer's performance. A music live show enabling bidirectional interaction is distributed using the virtual space. Such distribution can be also called large-scale real-time free viewpoint music live show distribution having interactivity.

Note that, in the present disclosure, video and shooting may be understood as meaning of image and imaging, and these may be appropriately read as long as there is no contradiction. In addition, the data may be understood as meaning of information, and they may be appropriately read as long as there is no contradiction. Transmission of data may be understood as meaning of data communication, data transmission/reception, data distribution, and the like, and they may be appropriately read as long as there is no contradiction.

In distribution using a virtual space including a large number of users, transmission and processing of enormous data occur, which cause a motion-to-photon latency or a delay in interaction between the users. This problem is addressed by the disclosed technique.

In one embodiment, all photonics communication (All Photonics Network (APN)) is used for data communication. A transmission path is configured with an optical fiber, and data is transmitted as an optical signal as it is without passing through photoelectric conversion. Routing of signals is conducted by an optical switch without involving a delay there. A delay, a decrease in a transmission rate, and delay fluctuation (jitter) due to multiplexing of other data do not occur or become very small. Since an optical fiber is used, a transmission delay is also very short.

In a case of distributing a live event in which a large number of users, for example, viewers on the order of one million people, participate, a data transmission amount and rendering processing for video generation become enormous, resulting in making a problem of delay conspicuous. Consideration of an approach different from the above-described all photonics communication is also important.

Although details will be described later, for example, components of the system and network resources required for implementing the system are defined. Taking advantage of characteristics of physical arrangement of network resources, components of the system are allocated (mapped) to the network resources. In addition, for 3D models of a performer and a viewer, 3D model data to be transmitted is selectively used depending on required quality and application. A format of data to be transmitted is defined between the components of the system according to processing contents. Compared with a general server-client configuration, a data rate between the components of the system can be reduced, a load of rendering processing for 3D scene generation and display can be dispersed, and a delay can be reduced. It is possible to distribute data to more users (scale-up of distribution).

Although 3D model data constituting a free viewpoint space is required to have high definition so that high image quality is secured even at a short distance viewpoint, an amount of data is enormous as compared with conventional 2D video data. In addition, it is necessary to process 3D model data of a large number of viewers who gather in a venue, and simply transmitting the 3D model data exceeds a transmission band capacity of a network. High speed computing resources are also required to process (render, etc.) enormous data.

In one embodiment, different 3D models are used for a performer and a viewer. Among them, a 3D model of a viewer is referred to also as an avatar. For example, movement of a performer is volumetrically captured to generate 3D model data of the performer changing in time series. Meanwhile, a 3D model of a viewer is configured with static 3D model data (avatar data) and animation data for moving the 3D model (for obtaining a dynamic avatar). Movement of the viewer is realized by reflecting the animation data in the 3D model data of the viewer.

Furthermore, as network resources constituting the system, three components are defined, for example, one central server device, a large number of edge server devices, and a larger number of client devices (on-premises devices). By devising geographical arrangement of network resources, a problem of data concentration on one place is alleviated, and a processing load is dispersed. Data concentration (locally high data rate) on a network is reduced, and a delay is also reduced. A free viewpoint real-time music live show distribution in a virtual space in which a large number of users participate can be provided.

### 1. Embodiment

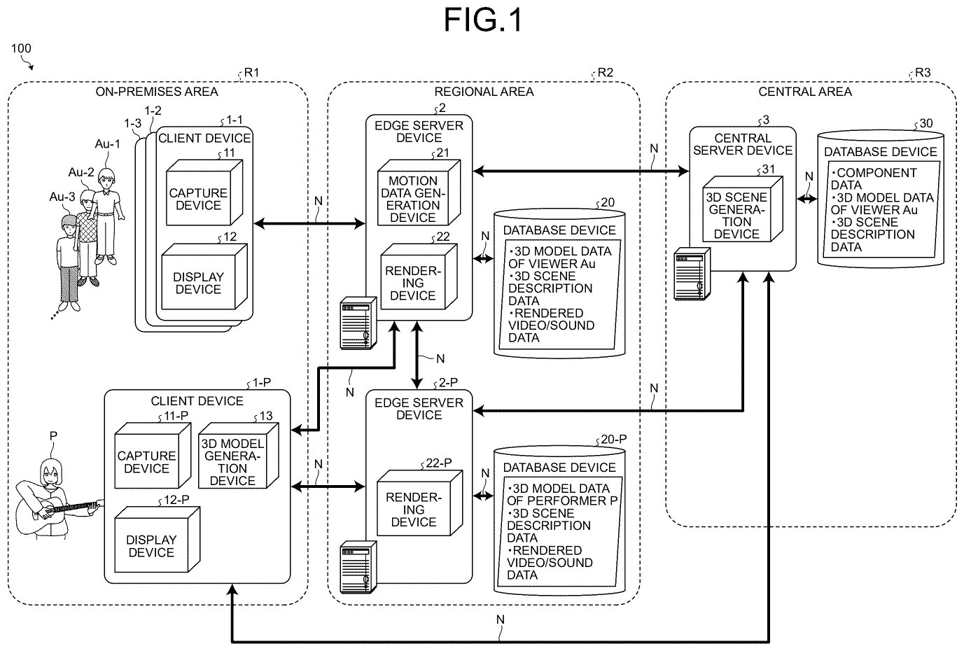

FIG. 1 is a diagram illustrating an example of a schematic configuration of a data distribution system 100 according to an embodiment. The data distribution system 100 distributes (provides) various events using a virtual space to a plurality of users. The event may be a live event. Live distribution (real-time distribution) of the event is performed. The virtual space includes a virtualized live event venue. Although examples of the event include a music live show, a sport, a talk show, and the like, the examples are not limited thereto. Note that, unless otherwise specified, the event is assumed to be a music live show in the following.

The virtual space is a three-dimensional virtual space (3D virtual space). Such a virtual space may be referred to also as a metaverse, a digital twin, or the like. A 3D model representing a user in the virtual space may be referred to also as an avatar, a digital human, or the like. The virtual space may be a virtual space including 3D models of a plurality of users, and a virtual space that changes in real time.

A plurality of users who uses the data distribution system 100 includes a viewer Au and a performer P. In a case where the viewer Au and the performer P are not distinguished from each other, they are simply referred to also as users. The viewer Au may be a plurality of viewers Au, and FIG. 1 exemplifies three viewers Au. The viewers Au are referred to as a viewer Au-1, a viewer Au-2, and a viewer Au-3, respectively, so as to be distinguishable. The performer P may be one or more performers P, and FIG. 1 exemplifies one performer P.

The data distribution system 100 includes a plurality of devices (also referred to as data processing devices or the like). Specifically, the data distribution system 100 includes a plurality of client devices, a plurality of edge server devices, one or more central server devices, and a plurality of database devices. FIG. 1 exemplifies a plurality of client devices 1 and a client device 1-P as the plurality of client devices. As the plurality of edge server devices, a plurality of edge server devices 2 and an edge server device 2-P are exemplified. One central server device 3 is exemplified as one or more central server devices. As the plurality of database devices, a database device 20, a database device 20-P, and a database device 30 are exemplified.

Each of the above-described devices is arranged in a distributed manner over a plurality of physically separated areas. The plurality of areas includes an on-premises area R1, a regional area R2, and a central area R3. Note that different devices illustrated in the same area in FIG. 1 can also be physically separated from each other.

In the on-premises area R1, the client device 1 and the client device 1-P are arranged. The client device 1 and the client device 1-P are devices (also referred to as on-premises devices) for direct use by the viewer Au and the performer P who are users, and are provided for each user.

There are a plurality of the client devices 1 corresponding to the number of the viewers Au. The client device 1 of the viewer Au-1 is illustrated as being referred to as a client device 1-1. The client device 1 of the viewer Au-2 is illustrated as being referred to as a client device 1-2. The client device 1 of the viewer Au-3 is illustrated as being referred to as a client device 1-3. When they are not particularly distinguished, they are simply referred to as the client device 1.

Each of the plurality of client devices including the client device 1 and the client device 1-P communicates with the corresponding edge server device 2. In addition, in this example, the client device 1-P communicates with not only the edge server device 2-P but also the edge server device 2 and the central server device 3.

The client device 1 of the viewer Au includes a capture device 11 and a display device 12.

The capture device 11 acquires data such as movement of a body, expression of a face, a position and orientation of each part of the body, and voice of the viewer Au. The capture device 11 may be configured to include a color camera, a depth sensor, a head mounted display (HMD), a controller, a microphone, and the like. An example of the color camera is an RGB camera or the like. An example of the depth sensor is a time of flight (ToF) sensor or the like. The HMD is used being attached to a head of the viewer Au. The controller is used, for example, while being held by the viewer Au by hand. The microphone collects voice of the viewer Au. The collected sound is sampled and digitized, for example. Data acquired by the capture device 11 is also referred to as capture data (or sensing data) of the viewer Au. Note that the capture device 11 may be configured to include an acceleration sensor or the like to be attached to the body of the viewer Au instead of or in addition to the color camera or the like. Data of an acceleration of the body part of the viewer Au obtained from the acceleration sensor, and further, data of a speed and a position of the part can be acquired as capture data.

The display device 12 displays a video of a virtual space and outputs sound. A display video of the display device 12 may be a video of the virtual space when viewed from a viewpoint of the viewer Au. The display video may include a 3D model of the performer P, and may include a 3D model of other viewer Au. An output sound of the display device 12 may include voice of the viewer Au and performance sound, and may include voice of other viewer Au. Video and sound are provided as if the viewer Au were at the live venue.

The client device 1-P of the performer P includes a capture device 11-P, a display device 12-P, and a 3D model generation device 13.

The capture device 11-P acquires data such as movement of a body, expression of a face, a position and orientation of each part of the body, voice, performance sound, and the like of the performer P. The capture device 11-P may be configured to include, for example, a color camera, a depth sensor, an HMD, a controller, a microphone, and the like. The camera may be numbers of cameras, whereby data such as the body movement of the performer P when viewed from numbers of different viewpoints is acquired (volumetric capture). In addition, the microphone may be a plurality of microphones. The data acquired by the capture device 11-P is referred to also as capture data of the performer P. The capture data of the performer P may be, for example, data obtained by capturing the movement of the performer P as a multi-viewpoint 2D video at a rate of 30 times or the like per second. Similarly to the capture device 11 described above, an acceleration sensor or the like may be included in the capture device 11-P.

The display device 12-P displays a video of the virtual space and outputs sound. A display video of the display device 12-P may be a video of the virtual space when viewed from a viewpoint of the performer P, or may be a video of the virtual space when viewed from a position different from the viewpoint of the performer P (a video including a 3D model of the performer P). As a result, the performer P can check reaction of the viewer Au and monitor the performer P himself/herself.

The 3D model generation device 13 generates 3D model data of the performer P on the basis of the capture data of the performer P acquired by the capture device 11-P. The 3D model data of the performer P includes first 3D model data and second 3D model data. The first 3D model data may be data of a 3D model with higher accuracy than the second 3D model data. The second 3D model data may have a smaller amount of data than the first 3D model data.

Examples of the first 3D model data are mesh data, texture data, point cloud data, and the like. The 3D model generation device 13 generates three-dimensional mesh data and texture data or generates point cloud data on the basis of image data or the like of the performer P included in the capture data of the performer P.

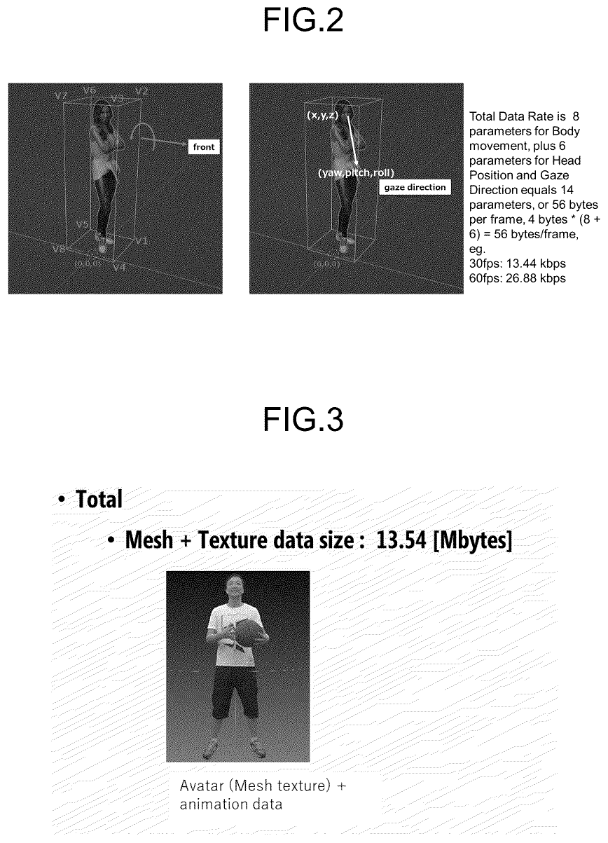

An example of the second 3D model data is bounding box data. The bounding box data will be described with reference also to FIG. 2.

FIG. 2 is a diagram illustrating an example of the bounding box data. The bounding box data is data described so as to surround a 3D model of the performer P. In this example, the bounding box data includes data indicating positions of eight vertices V1 to V8 of a rectangular parallelepiped surrounding the 3D model and indicating a front direction, and also includes data indicating an orientation of the face or a direction of a line of sight.

Although when restricted to a rectangular parallelepiped having each side parallel to xyz axes, the front direction is on a 90° basis, a side table is unnecessary. For example, a normal vector of a first surface, in this example, a surface defined by the vertex V1 to the vertex V4, is set to be the front. The line-of-sight direction is expressed by six parameters. For example, three parameters of x, y, and z indicate positions of eyes of the performer P, and three parameters of yaw, pitch, and roll indicate the line-of-sight direction.

A data amount of the bounding box data that is the second 3D model data is considerably smaller than a data amount of a general 3D model.

Returning to FIG. 1, for example, the 3D model generation device 13 transmits the first 3D model data among the generated 3D model data to (a rendering device 22-P of) the edge server device 2-P, and transmits the second 3D model data to (a 3D scene generation device 31 of) the central server device 3. Thus, by transmitting only the second 3D model data among the 3D model data to the central server device 3, a data transmission rate to the central server device 3 can be suppressed.

Returning to FIG. 1, the 3D model generation device 13 also generates sound data (audio data) having a listening position freely changed on the basis of data such as sound of the performer P, performance sound, and the like, among the capture data of the performer P. Examples of such audio data are data such as object audio, 3D audio, and 6 DoF (six degrees of freedom) audio.

In the regional area R2, a device that processes data to be transmitted to and from the client device 1 is arranged. The regional area R2 can be referred to also as a regional data center (DC) or the like.

Specifically, in the example illustrated in FIG. 1, the edge server device 2, the database device 20-P, the edge server device 2-P, and the database device 20-P are arranged in the regional area R2. The edge server device 2 is provided for the client device 1. The database device 20 is provided for the edge server device 2. The edge server device 2-P is provided for the client device 1-P. The database device 20-P is provided for the edge server device 2-P.

One edge server device 2 corresponds to one or two or more client devices 1, and thus, the number of the edge server devices 2 may be smaller than the number of the client devices 1. In the example illustrated in FIG. 1, one edge server device 2 corresponds to the client device 1-1 to the client device 1-3.

Note that a group of the client devices 1 to which the same edge server device 2 (the common edge server device 2) corresponds or a group of the viewers Au using these client devices 1 is referred to as a “viewer group” (audience group). In the example illustrated in FIG. 1, the client device 1-1 to the client device 1-3 or the viewer Au-1 to the viewer Au-3 belong to the same viewer group.

Each of the plurality of edge server devices including the edge server device 2 and the edge server device 2-P communicates with the central server device 3 and is dispersedly arranged at positions geographically separated from each other. Note that communication between the edge server devices 2 may also be possible. Each edge server device generates distribution data to a corresponding user on the basis of 3D scene description data generated by the 3D scene generation device 31 of the central server device 3 to be described later. An example of the distribution data is data of video and sound (video data and sound data) of the virtual space. The video data may be rendered video data.

The edge server device 2 includes a motion data generation device 21 and a rendering device 22. The database device 20 corresponding to the edge server device 2 stores data for use in the edge server device 2. Examples of data stored in the database device 20 include 3D model data of the viewer Au, 3D scene description data, and rendered video/sound data.

The 3D model data of the viewer Au in the database device 20 is, for example, data of a 3D model generated in advance or selected by the viewer Au from a plurality of prepared 3D models. The 3D model data of the viewer Au is stored in, for example, the database device 30 to be described later, and is transmitted to and stored in the database device 20 of the edge server device 2 corresponding to the client device 1 of the viewer Au before a live show starts. This 3D model data is data of a static 3D model of the viewer Au, and is moved on the basis of animation data to be described later. The 3D model data of the viewer Au will be described with reference also to FIG. 3.

FIG. 3 is a view illustrating an example of 3D model data (avatar data) of the viewer Au. The exemplified 3D model data includes geometry (mesh) data and texture data representing a color of a surface. The texture data occupies most of a data amount, and a data size of a 3D model of, for example, 50,000 polygons and 2K×2K texture, is about 13.54 Mbytes.

Returning to FIG. 1, the 3D scene description data in the database device 20 is data that describes a scene in a virtual space that includes 3D models of a plurality of users and changes in real time as described above. The 3D scene description data is, for example, data including description of components for constructing a venue, arrangement of 3D models of users (viewer Au, performer P), and the like. The 3D scene description data can be also said to be data like a design drawing for constructing a 3D scene.

The rendered video/sound data in the database device 20 is video data of a virtual space including a 3D model of the viewer Au, a 3D model of the performer P, and the like, and is sound data of a virtual space including voice of the viewer Au, voice of the performer P, performance sound, and the like, the video data and the sound data being after rendering is performed by the rendering device 22 and the rendering device 22-P to be described later. By recording such data in the database device 20, for example, even after a music live show ends, the viewer Au can watch the video of the music live show. The rendered video/sound data stored in the database device 20 may be video data when viewed from the viewpoint of the viewer Au and sound data heard at a position of the viewer Au.

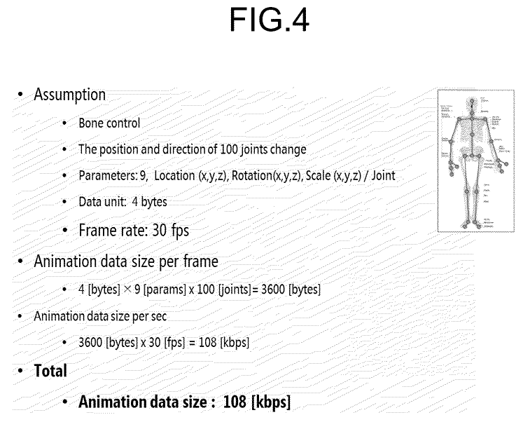

On the basis of capture data of a corresponding viewer Au, the motion data generation device 21 generates animation data (also referred to as motion data) of a 3D model of the viewer Au. The animation data is data indicating movement of a joint of a 3D model or the like, and is data for dynamically moving static 3D model data. The animation data will be described with reference also to FIG. 4.

FIG. 4 is a diagram illustrating an example of animation data. A data rate of the animation data when movement of the 3D model is expressed by positions and directions of hundred joints is 108 kbps in a case where a frame rate is 30 fps. Facial expression is also represented by joint movement. Its data amount is considerably smaller than the data of the moving 3D model itself.

Returning to FIG. 1, data specifying a reflection destination of the data, for example, a universally unique identifier (UUID) of a 3D model of the viewer Au, or the like can be added to the animation data. The UUID may be used also in the 3D scene description data. In the rendering device 22 to be described later, a position of the 3D model of the viewer Au designated by the 3D scene description data is specified using, for example, the UUID as a key.

The motion data generation device 21 may also generate data (visual field/line-of-sight data) indicating a visual field, a line of sight, and the like of the viewer Au. As a result, for example, the rendering device 22 to be described later can generate a video of a virtual space when viewed from the viewpoint of the viewer Au. Unless otherwise specified, the line of sight/visual field data is assumed to be included in the animation data.

The motion data generation device 21 also generates voice data of a 3D model of the viewer Au. The voice data may be included in the animation data or may be data different from the animation data. Unless otherwise specified, voice data is assumed to be also included in the animation data.

The motion data generation device 21 transmits the generated animation data to the central server device 3. What is transmitted is animation data representing a movement of the 3D model, and a dynamic 3D model data string (e.g., 3D model data updated 30 times per one second to express a movement) having a large data amount is not transmitted. A data transmission amount is accordingly reduced.

The rendering device 22 generates rendered video data of the virtual space on the basis of the 3D scene description data, the 3D model data of the viewer Au, and the 3D model data of the performer P. As described above, the 3D model data used here may be the first 3D model data such as mesh data, texture data, point cloud data, and the like. The video data is generated as distribution data during live, and is transmitted to a corresponding client device 1 (distributed to the viewer Au).

Specifically, the rendering device 22 generates video data of a virtual space when viewed from the viewpoint of the viewer Au by rendering on the basis of the 3D scene description data. The generated video data is transmitted to the display device 12 of the client device 1 of a corresponding viewer Au, and the video is displayed thereon. Note that sound data is also generated by the rendering device 22, for example, and transmitted up to the display device 12, where the sound is output.

The edge server device 2-P includes the rendering device 22-P. The database device 20-P corresponding to the edge server device 2-P stores data for use in the edge server device 2-P. Examples of the data stored in the database device 20-P include 3D model data, 3D scene description data, and rendered video/sound data of the performer P.

The 3D model data of the performer P in the database device 20-P is data of a 3D model of the performer P, and is generated by the 3D model generation device 13 as described above. The 3D scene description data is as described above.

The rendered video/sound data in the database device 20-P is video data of a virtual space including a 3D model of the viewer Au, a 3D model of the performer P, and the like after rendering is performed by the rendering device 22 and the rendering device 22-P, or sound data of a virtual space including a sound of the viewer Au, a sound of the performer P, a performance sound, and the like. By recording such data in the database device 20-P, for example, the performer P can watch a video of a music live show even after the music live show ends. The rendered video/sound data stored in the database device 20-P may be data of a video when the performer P is viewed from arbitrary viewpoint and position desired by the performer P, for example, the viewpoint and a position of the performer P or a viewpoint and a position different from the viewpoint and the position of the performer, and data of a sound heard at the position.

The rendering device 22-P generates rendered video data of the virtual space on the basis of the 3D scene description data, the 3D model data of the viewer Au, and the 3D model data of the performer P. The 3D model data for use here may also be the first 3D model data described above. The video data is generated as distribution data during the live show, and is transmitted to the client device 1-P (distributed to the performer P).

Specifically, the rendering device 22-P generates, by rendering, the video data of the virtual space when viewed from an arbitrary viewpoint desired by the performer P on the basis of the 3D scene description data. The generated video data is transmitted to the client device 1-P, and the video is displayed thereon. Note that sound data is also generated by, for example, the rendering device 22-P and transmitted up to the display device 12, where the sound is output.

In the central area R3, a device is arranged that processes data to be transmitted to and from the regional area R2 and further to and from the on-premises area R1. The central area R3 can be referred to also as a central data center (DC) or the like.

Specifically, in the example illustrated in FIG. 1, the central server device 3 and the database device 30 are arranged in the central area R3. The central server device 3 is provided for the edge server device 2.

The central server device 3 may be one (single) central server device 3 or a plurality of the central server devices 3. One central server device 3 corresponds to one or two or more edge server devices 2, and thus, the number of the central server devices 3 may be smaller than the number of the edge server devices 2. In the example illustrated in FIG. 1, the central server device 3 is one central server device 3.

The central server device 3 includes the 3D scene generation device 31. The database device 30 corresponding to the central server device 3 stores data for use by the central server device 3. Examples of the data stored in the database device 30 include component data, the 3D model data of the viewer Au, and the 3D scene description data.

The component data in the database device 30 is data of components constituting a virtual space including a live venue. Examples of the component include a stage, an audience seat, and a lighting.

The 3D model data of the viewer Au and the 3D scene description data in the database device 30 are as described so far.

In order for the 3D scene generation device 31 to generate 3D scene description data, the 3D scene generation device 31 constructs a virtual space including a live venue. For example, a virtual space that changes in real time is constructed on the basis of the component data in the database device 30, the animation data from the motion data generation device 21 of the edge server device 2, the 3D model data of the performer P from the 3D model generation device 13 of the client device 1-P, and the like. The 3D model data for use here may be the second 3D model data (bounding box data) as described above.

For example, various components are arranged in the virtual space on the basis of the component data, thereby providing a video effect (visual effect) and the like in the virtual space. Furthermore, the 3D model of the performer P and the 3D model of the viewer Au are arranged in the live venue in the virtual space. Positions, movements, and the like of these 3D models change in real time on the basis of the animation data and the second 3D model data (bounding box data). Data describing the scene is generated as 3D scene description data.

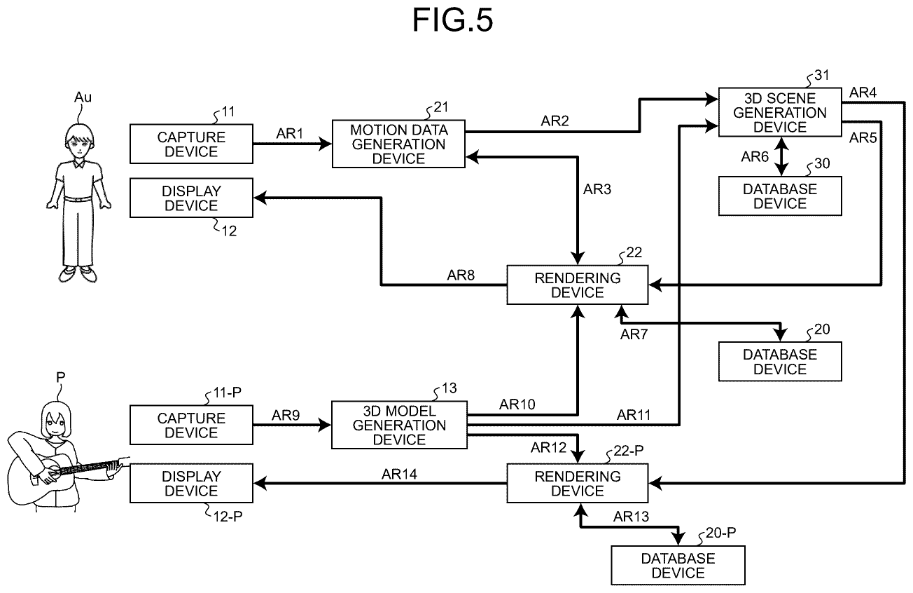

As described above, the devices constituting the data distribution system 100 are configured to be able to communicate with each other. As schematically illustrated in FIG. 1, communication is performed via a network N. Connection and data transmission between the devices connected via the network N will be described with reference also to FIG. 5.

FIG. 5 is a diagram illustrating an example of connection and data transmission between the devices. Some data transmissions between the devices described so far are indicated by arrows AR1 to AR14.

The arrow AR1 indicates data transmission from the capture device 11 to the motion data generation device 21. For example, capture data of the viewer Au acquired by the capture device 11 is transmitted.

The arrow AR2 indicates data transmission from the motion data generation device 21 to the 3D scene generation device 31. For example, animation data and voice data of a 3D model of the viewer Au are transmitted.

The arrow AR3 indicates data transmission between the motion data generation device 21 and the rendering device 22. For example, the animation data of the 3D model of the viewer Au is transmitted.

The arrow AR4 indicates data transmission from the 3D scene generation device 31 to the rendering device 22-P. For example, the 3D scene description data is transmitted.

The arrow AR5 indicates data transmission from the 3D scene generation device 31 to the rendering device 22. For example, the 3D scene description data is transmitted.

The arrow AR6 indicates data transmission between the 3D scene generation device 31 and the database device 30. For example, the component data, the 3D model data of the viewer Au, and the 3D scene description data are transmitted.

The arrow AR7 indicates data transmission between the rendering device 22 and the database device 20. For example, the 3D model data of the viewer Au, the 3D scene description data, and the rendered video/sound data are transmitted.

The arrow AR8 indicates data transmission from the rendering device 22 to the display device 12. For example, the rendered video/sound data is transmitted.

The arrow AR9 indicates data transmission from the capture device 11-P to the 3D model generation device 13. For example, the capture data of the performer P is transmitted.

The arrow AR10 indicates data transmission from the 3D model generation device 13 to the rendering device 22. For example, among the data of the 3D model of the performer P, the first 3D model data (point cloud data, mesh/texture data, and the like) is transmitted.

The arrow AR11 indicates data transmission from the 3D model generation device 13 to the 3D scene generation device 31. For example, the second 3D model data (bounding box data) among the data of the 3D model of the performer P, voice data, and the like are transmitted.

The arrow AR12 indicates data transmission from the 3D model generation device 13 to the rendering device 22-P. For example, among the data of the 3D model of the performer P, the first 3D model data (point cloud data, mesh/texture data, and the like) is transmitted.

The arrow AR13 indicates data transmission between the rendering device 22-P and the database device 20-P. For example, the 3D model data of the performer P, the 3D scene description data, and the rendered video/sound data are transmitted.

The arrow AR14 indicates data transmission from the rendering device 22-P to the display device 12-P. For example, the rendered video/sound data is transmitted.

For example, by performing the data transmission as described above, each device (component) constituting the data distribution system 100 can be used in a distributed arrangement on the network N. Each device may also be referred to as a network resource available on the network N.

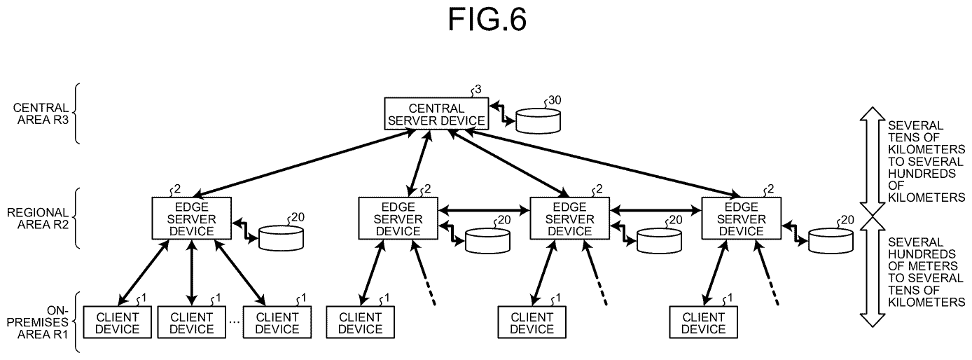

By connecting the devices and performing the data transmission in the manner as described above, the data processing load can be dispersed and the data transmission can also be dispersed. As a result, the delay as described at the beginning can be reduced. In one embodiment, the network N may be an all photonics network, and communication between the devices by using the network N may be all photonics communication. A delay reduction effect is further enhanced. As a result, it is possible to provide data distribution to many users, in this example, provide large-scale free viewpoint real-time music live show distribution. Description will be given with reference also to FIG. 6.

FIG. 6 is a diagram illustrating an example of sharing of network resources. A basic network configuration is a server-client model, and the exemplified network configuration has a hierarchical structure. The plurality of edge server devices 2 arranged in the regional area R2 is connected to one central server device 3 arranged in the central area R3. In addition, one or a plurality of client devices 1 arranged in the on-premises area R1 is connected to each edge server device 2.

An example of a physical distance between the devices is also illustrated in FIG. 6. In this example, a distance between the client device 1 and the edge server device 2 is several hundreds of meters to several tens of kilometers. A distance between the edge server device 2 and the central server device 3 is several tens of kilometers to several hundreds of kilometers.

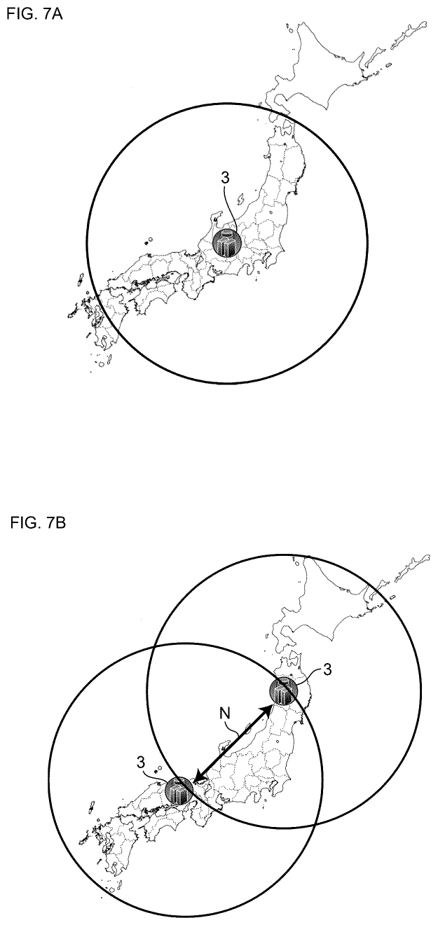

As described above, the central server device 3 may be one central server device 3 or a plurality of the central server devices 3. As a distribution target region covered by only one central server device 3 becomes wider, a delay on the network N may become conspicuous. This problem can be addressed, for example, by using a plurality of the central server devices 3 communicable with each other via the network N. This is because it is possible to prevent the distribution target region covered by one central server device 3 from becoming too wide. As a result, for example, it is possible to suppress deterioration in user experience due to delay. Description will be given with reference also to FIG. 7.

FIG. 7 is a diagram illustrating an example of arrangement of the central server device 3. A range in which the data distribution system 100 can distribute data is schematically indicated by a circle including the central server device 3 inside. In an example illustrated in (A) of FIG. 7, only one central server device 3 covers all distribution target regions. By contrast, in an example illustrated in (B) of FIG. 7, all the distribution target regions cannot be covered by one central server device 3, and thus, all the distribution target regions are covered by using two central server devices 3 arranged at different positions and capable of communicating with each other.

Note that, in a case where a plurality of the central server devices 3 is used, a communication overhead between the central server devices 3, a server use cost, and the like are required. In a case where only one central server device 3 is used, there is no need for these.

Returning to FIG. 6, the edge server device 2 is interposed between the central server device 3 and the client device 1. The edge server devices 2 are arranged such that a distribution target region covered by the central server device 3 is further divided, and one edge server device 2 is in charge of each one of the divided regions.

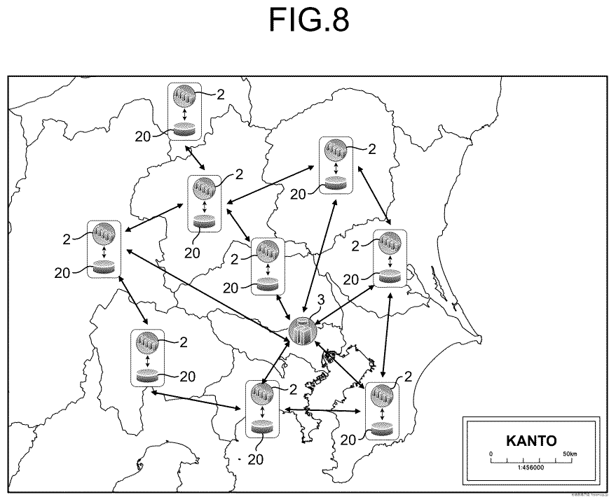

Several methods (designing methods) for deciding a geographical position of the edge server device 2 will be described. For example, the edge server devices 2 may be arranged such that a distance between the edge server devices 2 is substantially equal. This brings an advantage that designing is easy. The arrangement of the edge server devices 2 may be changed according to a density of the client devices 1. Loads of the edge server devices 2 can be leveled. Description will be given with reference also to FIG. 8.

FIG. 8 is a diagram illustrating an example of geographical arrangement of the edge server devices 2. The edge server devices 2 are arranged according to the density of the client devices 1. The edge server devices 2 are arranged, for example, such that the number of the client devices 1 corresponding to each edge server device 2 is the same or close.

Referring back to FIG. 6, the edge server devices 2 may communicate with each other via the central server device 3 or may directly communicate without via the central server device 3. For example, the edge server devices 2 arranged close to each other may directly communicate with each other. The edge server devices 2 arranged apart from each other may communicate with each other via the central server device 3.

The client device 1 basically performs data transmission with the edge server device 2 located at the physically closest distance. As a result, a delay caused by data transmission between the client device 1 and the edge server device 2 is minimized.

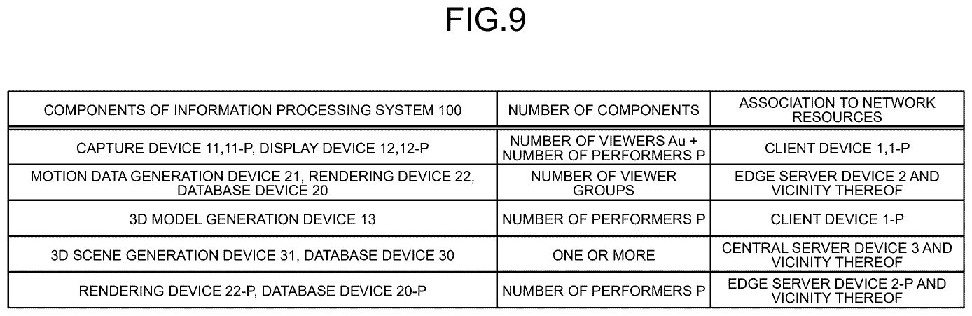

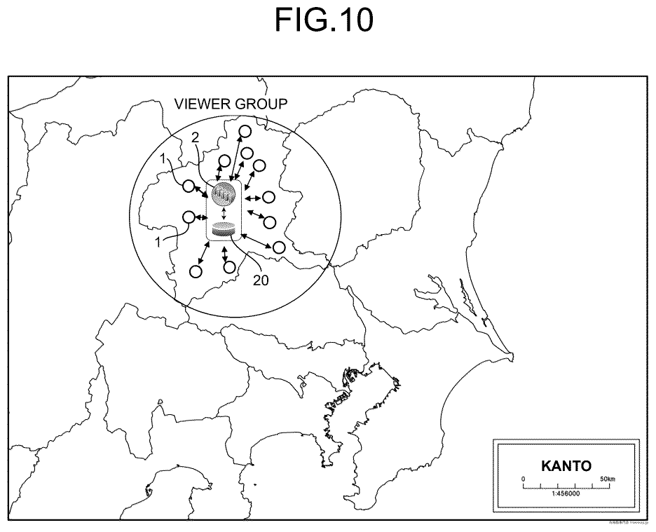

The components of the data distribution system 100 are associated (mapped) with the network resources as illustrated in FIG. 6. Description will be given with reference also to FIG. 9.

FIG. 9 is a diagram illustrating an example of mapping. The components of the data distribution system 100, the number of the components, and a relationship of association to the network resources are shown in a table.

As the components of the data distribution system 100, there are shown the capture device 11, the capture device 11-P, the display device 12, the display device 12-P, the motion data generation device 21, the rendering device 22, the database device 20, the 3D model generation device 13, the 3D scene generation device 31, the database device 30, the rendering device 22-P, and the database device 20-P which have been described so far.

The number of the capture devices 11 and the capture device 11-P is the same as the number of the viewers Au and the number of the performers P. These components are arranged in the client device 1 and in the client device 1-P and are associated with the network resources.

The number of the motion data generation devices 21, the rendering devices 22, and the database devices 20 is the same as the number of the viewer groups, and these components are arranged in the edge server device 2 and in the vicinity thereof and are associated with the network resources.

The number of the 3D model generation devices 13 is the same as the number of the performers P, and this component is arranged in the client device 1-P and is associated with the network resource.

The number of the 3D scene generation devices 31 and the database devices 30 are one or more, and these components are arranged in the central server device 3 and in the vicinity thereof and are associated with the network resources.

The numbers of the rendering devices 22-P and the database devices 20-P are the same as the number of the performers P, and these components are arranged in the edge server device 2-P and in the vicinity thereof and are associated with the network resources.

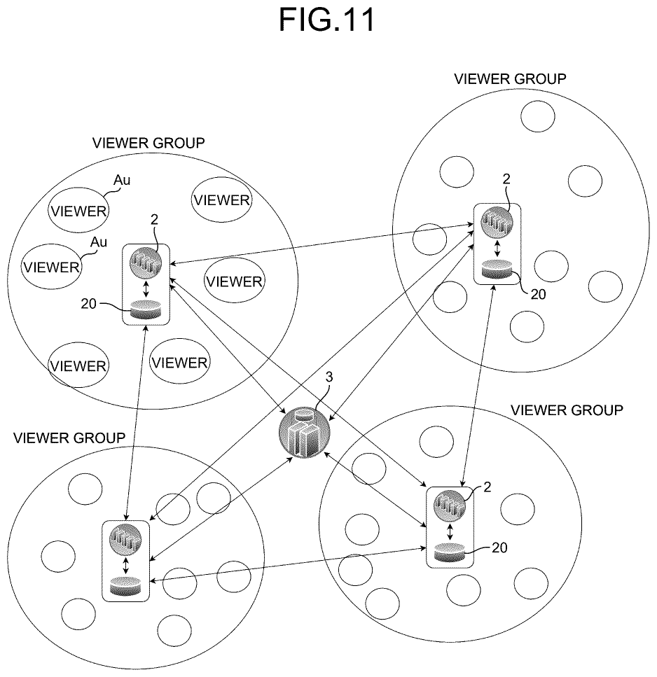

The viewer group will be described again. The viewer group indicates a group of the client devices 1 to which the same edge server device 2 corresponds or a group of the viewers Au using the client devices 1. The client devices 1 or the viewers Au belonging to the same viewer group are located physically close to the same edge server device 2, for example. Description will be given with reference also to FIGS. 10 and 11.

FIGS. 10 and 11 are diagrams illustrating examples of viewer groups. Each of a plurality of the viewer groups is schematically indicated by a circle. A geographical scale of the client device 1 or the viewer Au belonging to the same viewer group may be, for example, about several km to 100 km around the edge server device 2. In a case of Japan, although it is merely an example, the edge server device 2 may be arranged in each prefecture, and there may be a viewer group corresponding thereto.

Since the client devices 1 in a group belonging to a certain viewer group are positioned at a physically close distance, it is characteristic that a response delay is reduced in a case where interaction is performed through conversation, body movement, or the like of the viewers Au who use the client devices 1 in the same virtual space. From the viewpoint of utilizing such a characteristic, in one embodiment, the virtual space may be basically constructed so as to provide one live venue for one viewer group. The 3D scene generation device 31 of the central server device 3 may generate a 3D scene of each live venue.

Since when the network N is an all photonics network, there is no variation in delay, and a maximum delay time can be estimated from a geographical scale of the viewer group, natural interaction between the 3D models of the viewer Au gathering at the same live venue can be guaranteed. Assuming that minimum time during which a person can perceive a response delay is, for example, 50 ms (milliseconds), when a range of a viewer group is decided so that the maximum delay time falls within 50 ms, natural interaction without perception of a delay can be provided to the 3D model of the viewer Au belonging to the viewer group. When a distribution region of a music live show is divided into the viewer groups on the basis of such an idea, it is also possible to provide natural interaction to the 3D models of all the viewers Au.

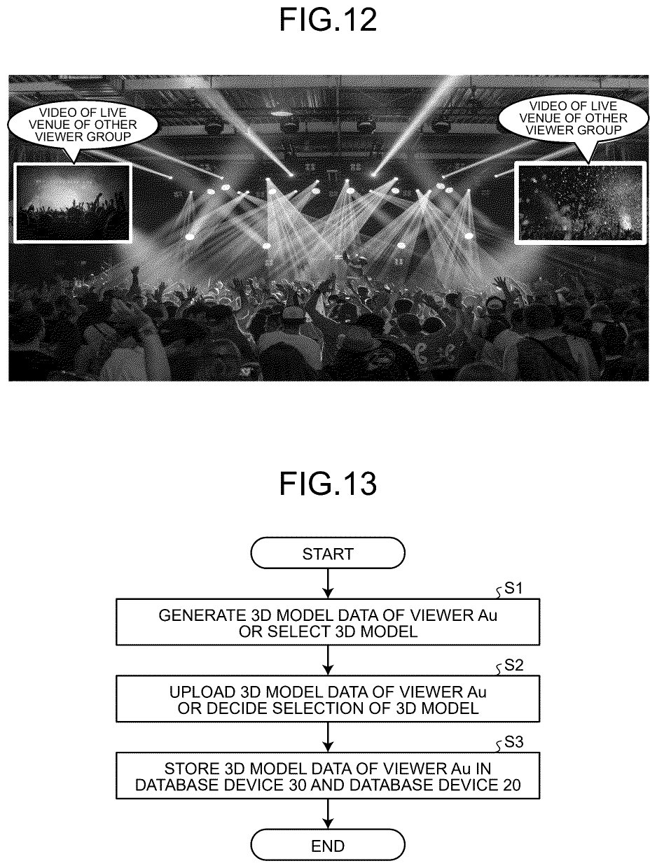

Meanwhile, between 3D models of viewers Au belonging to different viewer groups, it may be difficult to guarantee provision of as natural interaction as that between 3D models of viewers Au belonging to the same viewer group. In that case, for example, a huge video panel may be installed in a music live venue in a virtual space to display a state of a music venue of other viewer group, thereby realizing interaction between the 3D models of the viewers Au in the respective music venues. Description will be given with reference to FIG. 12.

FIG. 12 is a diagram illustrating an example of interaction between 3D models of viewers Au belonging to different viewer groups. For example, a video of a virtual space as illustrated in FIG. 12 is displayed by the display device 12 of the client device 1 used by the viewer Au belonging to a certain viewer group. On both sides of a screen, videos of live venues of other viewer groups are displayed. Note that the shorter a physical distance between viewer groups, the smaller a delay in interaction between the 3D models of the viewers Au belonging to those viewer groups.

FIGS. 13 to 22 are diagrams illustrating examples of operation of the data distribution system 100 (a data distribution method, a data distribution system). The operation of the data distribution system 100 from before distribution to during distribution (from before start of a live show to during the live show) will be described in several stages.

### <Before Distribution>

### <Distribution Preparation>

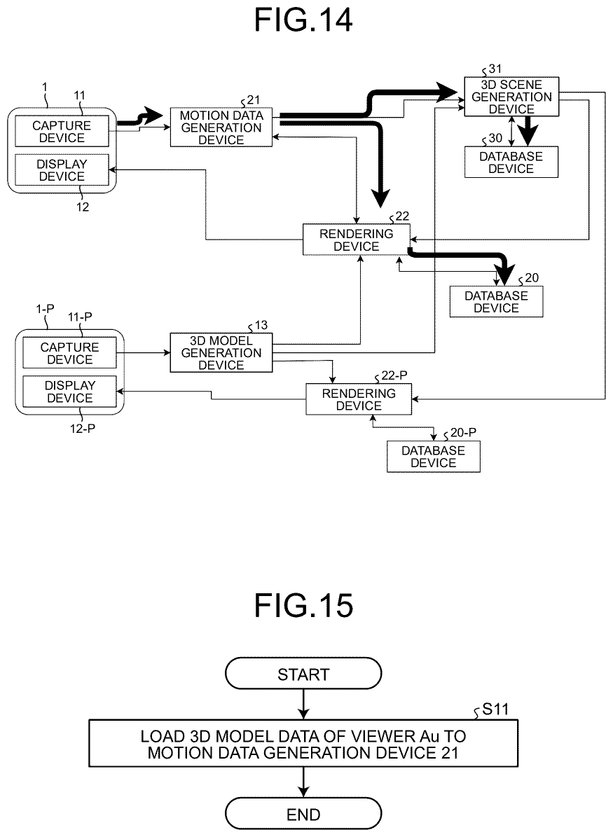

FIGS. 13 and 14 are diagrams illustrating an example of operation of the data distribution system 100 at distribution preparation stage. FIG. 13 illustrates some processing executed in the data distribution system 100. In FIG. 14, several data transmissions in the data distribution system 100 are indicated by thick arrows.

In Step S1, 3D model data of the viewer Au is generated or a 3D model is selected. The generation of the 3D model data of the viewer Au is performed, for example, on the basis of the capture data of the viewer Au acquired by the capture device 11 of the client device 1 of the viewer Au. The generation may be performed by the edge server device 2 or may be performed by the central server device 3. As described above, the selection of the 3D model is performed by the viewer Au selecting his or her own 3D model from several 3D models prepared in advance. The selection may be performed using, for example, the controller (an example of the capture device 11) described above, the display device 12, or the like.

In Step S2, the 3D model data of the viewer Au is uploaded, or selection of the 3D model is decided. In a case where the 3D model of the viewer Au is generated in the previous Step S1, its data is transmitted up to the database device 30 and the database device 20. Note that the 3D model data of the viewer Au is transmitted to the database device 20 corresponding to the edge server device 2 corresponding to the client device 1 of the viewer Au. When the 3D model is selected in the previous Step S1, the data of the selected 3D model is decided as the data of the 3D model of the viewer Au. The decided 3D model data of the viewer Au is transmitted up to the database device 30 and the database device 20. Note that, in a case where the 3D model data of the viewer Au has already been stored in the database device 30 or the database device 20, data transmission to that device is unnecessary.

In Step S3, the 3D model data of the viewer Au is stored in the database device 30 and the database device 20. The 3D model data transmitted in the previous Step S2 is stored in a database device of a transmission destination.

For example, as described in the foregoing, at a stage of distribution preparation, the 3D model data of the viewer Au is transmitted to and stored in the database device 30 and the database device 20. Since the 3D model of the viewer Au has a large amount of data, there is an advantage that data can be transmitted without being restricted by a transmission speed or the like (in non-real time) by performing transmission to the database device 30 and the database device 20 before distribution.

### <Preparation Immediately Before Distribution>

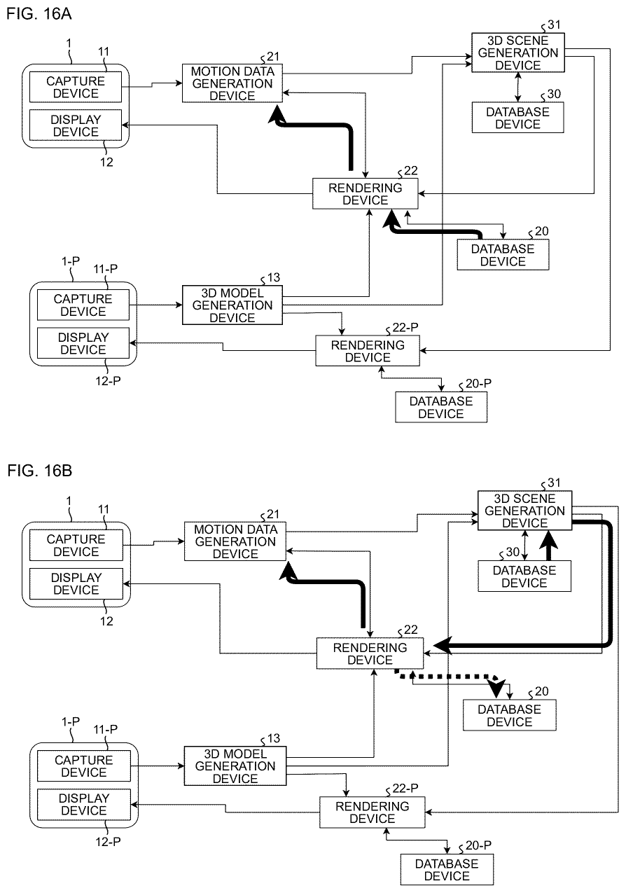

FIGS. 15 and 16 are diagrams illustrating an example of operation of the data distribution system 100 at a preparation stage immediately before distribution. FIG. 15 illustrates some processing executed in the data distribution system 100. In FIG. 16, several data transmissions in the data distribution system 100 are indicated by thick arrows.

In Step S11, the 3D model data of the viewer Au is loaded into the motion data generation device 21. For example, as illustrated in (A) of FIG. 16, the 3D model data of the viewer Au in the database device 20 is transmitted up to the motion data generation device 21. Alternatively, as illustrated in (B) of FIG. 16, the 3D model data of the viewer Au in the database device 30 is transmitted up to the motion data generation device 21.

For example, as described in the foregoing, at the preparation stage immediately before distribution, the 3D model data of the viewer Au is transmitted up to the motion data generation device 21 and is brought to be immediately available in the motion data generation device 21. Thereafter, distribution is started.

### <In Distribution>

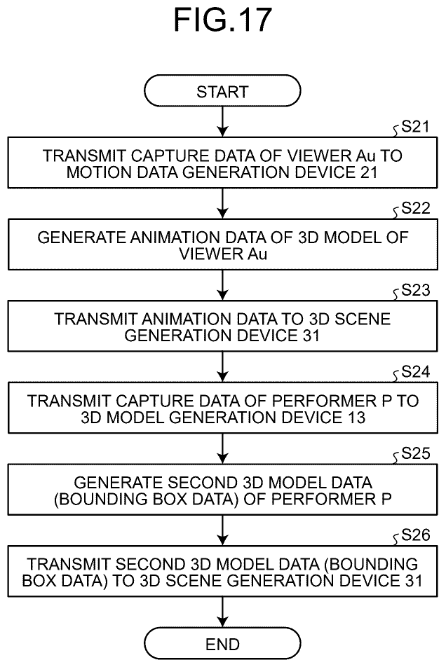

FIGS. 17 to 22 are diagrams illustrating an example of operation of the data distribution system 100 in distribution.

### <Capture>

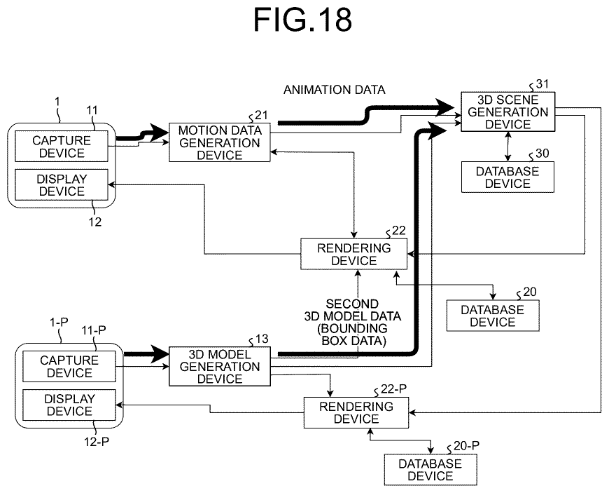

FIGS. 17 and 18 are diagrams illustrating an example of operation of the data distribution system 100 regarding acquisition (capture) of information of the viewer Au and the performer P. FIG. 17 illustrates some processing executed in the data distribution system 100. In FIG. 18, several data transmissions in the data distribution system 100 are indicated by thick arrows.

In Step S21, capture data of the viewer Au is transmitted to the motion data generation device 21. The capture device 11 acquires the capture data of the viewer Au and transmits the capture data to the motion data generation device 21. The motion data generation device 21 receives the capture data from the capture device 11.

In Step S22, animation data of the 3D model of the viewer Au is generated. The motion data generation device 21 generates animation data of the 3D model of the viewer Au on the basis of the capture data of the viewer Au received in the previous Step S1 and the 3D model data of the viewer Au loaded from the database device 20.

In Step S23, the animation data is transmitted to the 3D scene generation device 31. The motion data generation device 21 transmits the animation data generated in the previous Step S22 to the 3D scene generation device 31. The 3D scene generation device 31 receives the animation data from the motion data generation device 21.

In Step S24, capture data of the performer P is transmitted to the 3D model generation device 13. The capture device 11-P acquires the capture data of the performer P and transmits the capture data to the 3D model generation device 13. The 3D model generation device 13 receives the capture data from the capture device 11-P.

In Step S25, second 3D model data of the performer P, for example, bounding box data, is generated. The 3D model generation device 13 generates second 3D model data of the performer P on the basis of the capture data of the performer P received in the previous Step S24.

In Step S26, the second 3D model data is transmitted to the 3D scene generation device 31. The 3D model generation device 13 transmits the second 3D model data of the performer P generated in the previous Step S25 to the 3D scene generation device 31. The 3D scene generation device 31 receives the second 3D model data from the 3D model generation device 13.

For example, in the above-described manner, the capture data of the viewer Au and the performer P in distribution is acquired, and the animation data and the second 3D model data are transmitted up to the 3D scene generation device 31.

Note that the processing in Steps S21 to S23 and the processing in Steps S24 to S26 described above may be executed in reverse order or may be executed in parallel.

### <Generation of Distribution Data>

### <Generation of Distribution Data to Viewer Au>

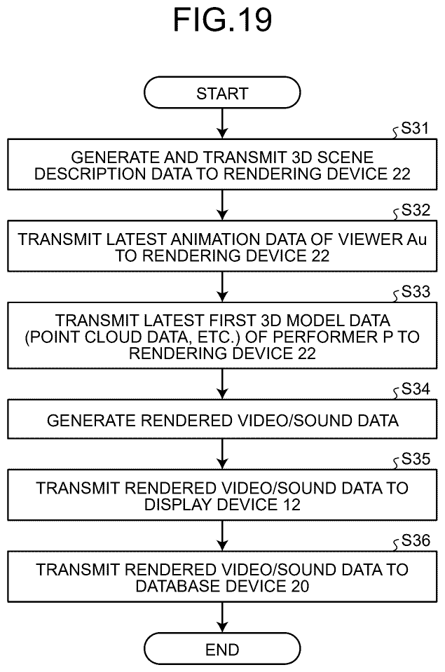

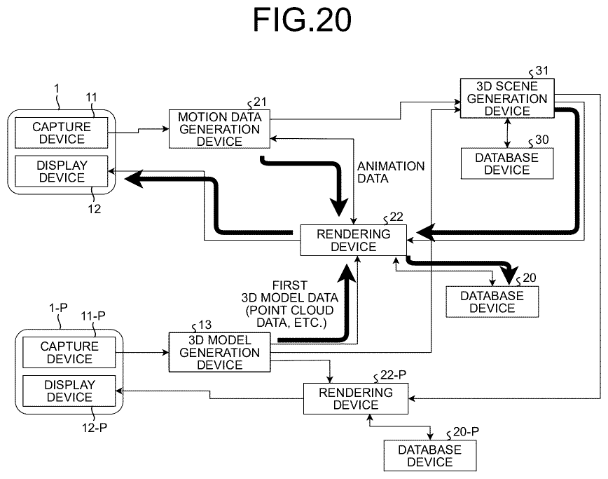

FIGS. 19 and 20 illustrate an example of operation of the data distribution system 100 regarding generation of a distribution video to the viewer Au. FIG. 19 illustrates some processing executed in the data distribution system 100. In FIG. 20, several data transmissions in the data distribution system 100 are indicated by thick arrows.

In Step S31, 3D scene description data is generated and transmitted to the rendering device 22. The 3D scene generation device 31 constructs a 3D scene on the basis of the animation data of the 3D model of the viewer Au and the second 3D model data (bounding box data) of the performer P. For example, the 3D scene generation device 31 constructs a virtual space including a live venue on the basis of the component data in the database device 30, and arranges the 3D model of the viewer Au in the virtual space on the basis of the 3D model data of the viewer Au in the database device 30. In addition, the 3D scene generation device 31 decides a position of the performer P in the virtual space (e.g., arranged on the stage) on the basis of the second 3D model data of the performer P. The 3D scene generation device 31 generates data describing thus obtained 3D scene as 3D scene description data, and transmits the data to the rendering device 22. The rendering device 22 receives the 3D scene description data from the 3D scene generation device 31.

In Step S32, latest animation data of the viewer Au is transmitted to the rendering device 22. The latest animation data can be also said to be data reflecting latest capture data of the viewer Au (reflecting movement of the viewer Au in real time). The motion data generation device 21 generates, for example, latest animation data (including visual field/line-of-sight data) of the viewer Au and transmits the animation data to the rendering device 22. The rendering device 22 receives the latest animation data of the viewer Au from the motion data generation device 21.

In Step S33, latest first 3D model data (point cloud data or the like) of the performer P is transmitted to the rendering device 22. The latest first 3D model data can also be said to be data reflecting latest capture data of the performer P (reflecting movement of the performer P in real time). The 3D model generation device 13 generates latest first 3D model data of the performer P and transmits the data to the rendering device 22. The rendering device 22 receives the latest first 3D model data of the performer P from the 3D model generation device 13.

In Step S34, rendered video/sound data is generated. The rendering device 22 generates rendered video/sound data on the basis of the 3D scene description data, the 3D model data and the animation data of the viewer Au, the first 3D model data and the capture data of the performer P, and the like. This data is distribution data to the viewer Au.

In Step S35, the rendered video/sound data is transmitted to the display device 12. The rendering device 22 transmits the rendered video/sound data generated in the previous Step S34 to the display device 12. The display device 12 receives and outputs the rendered video/sound data from the rendering device 22 (video display and sound output).

In Step S36, the rendered video/sound data is transmitted to the database device 20. The rendering device 22 transmits the rendered video/sound data generated in the previous Step S34 to the database device 20. The database device 20 receives and stores the rendered video/sound data from the rendering device 22.

For example, in the above-described manner, the distribution data including the video/sound data is distributed to the viewer Au.

### <Generation of Distribution Data to Performer P>

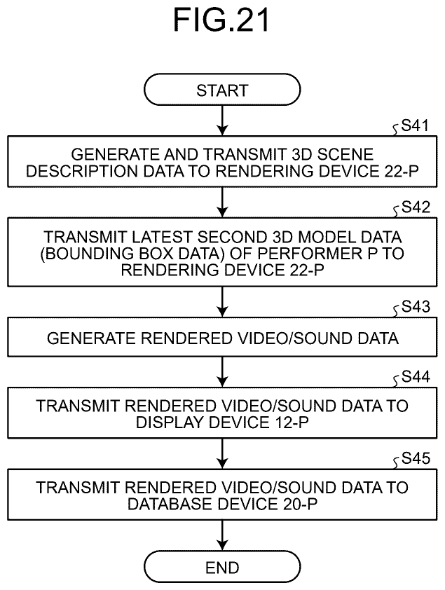

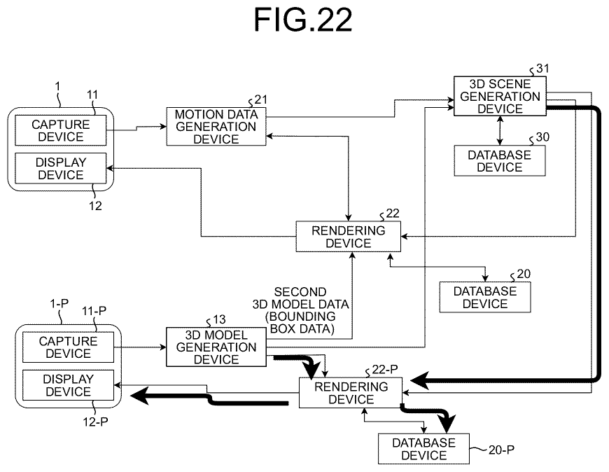

FIGS. 21 and 22 illustrate an example of operation of the data distribution system 100 regarding generation of a distribution video to the performer P. FIG. 21 illustrates some processing executed in the data distribution system 100. In FIG. 22, some data transmissions in the data distribution system 100 are indicated by thick arrows.

In Step S41, 3D scene description data is generated and transmitted to the rendering device 22-P. The 3D scene generation device 31 generates 3D scene description data as described so far, and transmits the 3D scene description data to the rendering device 22-P. The rendering device 22-P receives the 3D scene description data from the 3D scene generation device 31.

In Step S42, latest second 3D model data (bounding box data) of the performer P is transmitted to the rendering device 22-P. The latest second 3D model data can also be said to be data reflecting the latest capture data of the performer P (reflecting movement of the performer P in real time). The 3D model generation device 13 generates latest second 3D model data of the performer P and transmits the data to the rendering device 22-P. The rendering device 22-P receives the latest second 3D model data of the performer P from the 3D model generation device 13.

In Step S43, rendered video/sound data is generated. The rendering device 22-P generates rendered video/sound data on the basis of the 3D model data and the animation data of the viewer Au, the second 3D model data of the performer P, and the like. This data is distribution data to the performer P.

In Step S44, the rendered video/sound data is transmitted to the display device 12-P. The rendering device 22-P transmits the rendered video/sound data generated in the previous Step S43 to the display device 12-P. The display device 12-P receives and outputs the rendered video/sound data from the rendering device 22-P (video display and sound output).

In Step S45, the rendered video/sound data is transmitted to the database device 20-P. The rendering device 22-P transmits the rendered video/sound data generated in the previous Step S43 to the database device 20-P. The database device 20-P receives and stores the rendered video/sound data from the rendering device 22-P.

For example, in the above-described manner, the distribution data including the video/sound data is distributed to the performer P.

According to the data distribution system 100 described in the foregoing, since each of the plurality of edge server devices 2 and 2-P arranged in a dispersed manner generates distribution data to the corresponding viewer Au and performer P, a processing load is dispersed. Furthermore, for example, the second 3D model data (bounding box data) among the 3D model data of the performer P is transmitted from the client device 1-P to the central server device 3. The animation data of the 3D model of the viewer Au is transmitted from the edge server device 2 to the central server device 3. The 3D scene description data is transmitted from the central server device 3 to the edge server device 2 and the edge server device 2-P. By transmitting data of such a format, a data transmission amount in the central server device 3 can be reduced. Therefore, it is possible to suppress a delay that may occur due to concentration of a processing load or an increase in a data transmission amount, for example, a motion-to-photon latency, a delay in interaction between 3D models of the users in the virtual space, or the like. A comparative example and a consideration example will also be described.

### Comparative Example

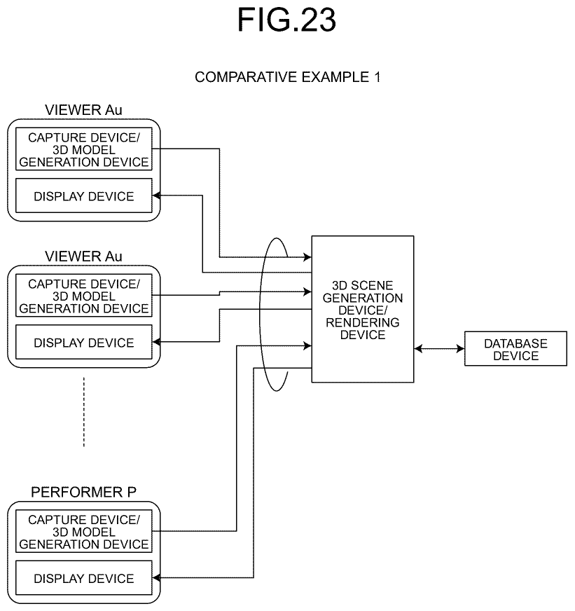

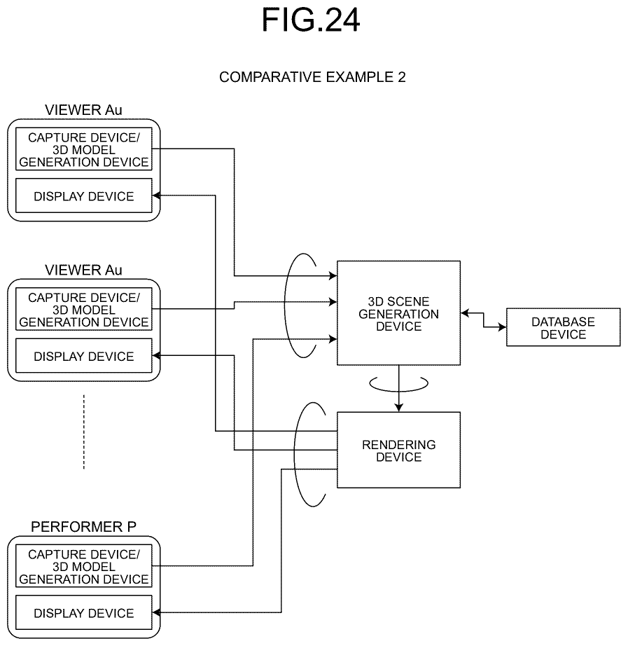

FIGS. 23 and 24 are diagrams illustrating comparative examples. Comparative Example 1 illustrated in FIG. 24 is a typical server-client configuration. A 3D scene generation device/rendering device corresponds to a server. The configuration of Comparative Example 1 has a problem that input data and the output data are concentrated on the server. In the server, 3D model data (e.g., corresponding to the first 3D model data described above) of users (a viewer Au and a performer P) is input, and a rendering video different for each user is generated and distributed to the corresponding user. For example, in a case where an input data rate per user is 100 Mbps, when the number of users is one million, a total input data rate is 100 T (tera) bps.

In Comparative Example 2 illustrated in FIG. 24, concentration of data and a processing load is more alleviated as compared with Comparative Example 1. In Comparative Example 2, a 3D scene generation device that receives 3D model data of users (a viewer Au and a performer P) and a rendering device that generates a video to be distributed to the users are separated. Since a rendered video is output from the rendering device, input data from the user and output data thereto are not concentrated on one device. However, there is no difference in that 3D model data of all users concentrates on the 3D scene generation device, and a problem remains (problem (a)). In addition, since all data constituting a 3D scene is transmitted from the 3D scene generation device to the rendering device, there remains a problem (problem (b)) that a data transmission rate between the 3D scene generation device and the rendering device is very high.

### Consideration Example

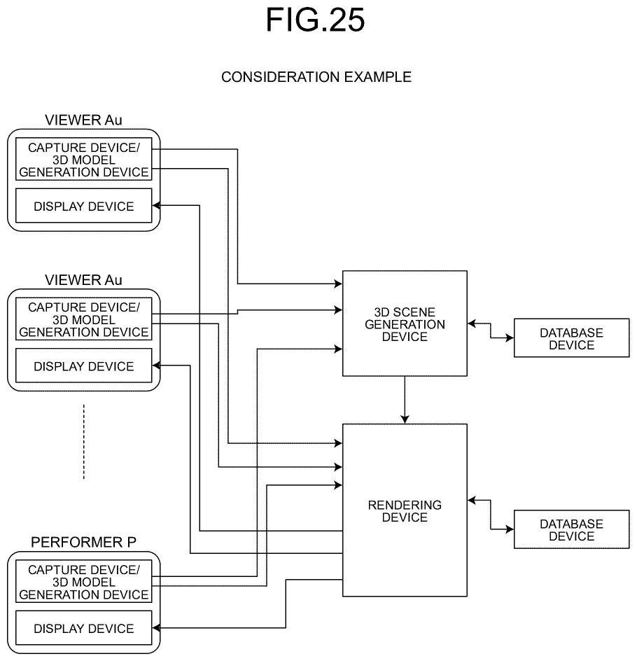

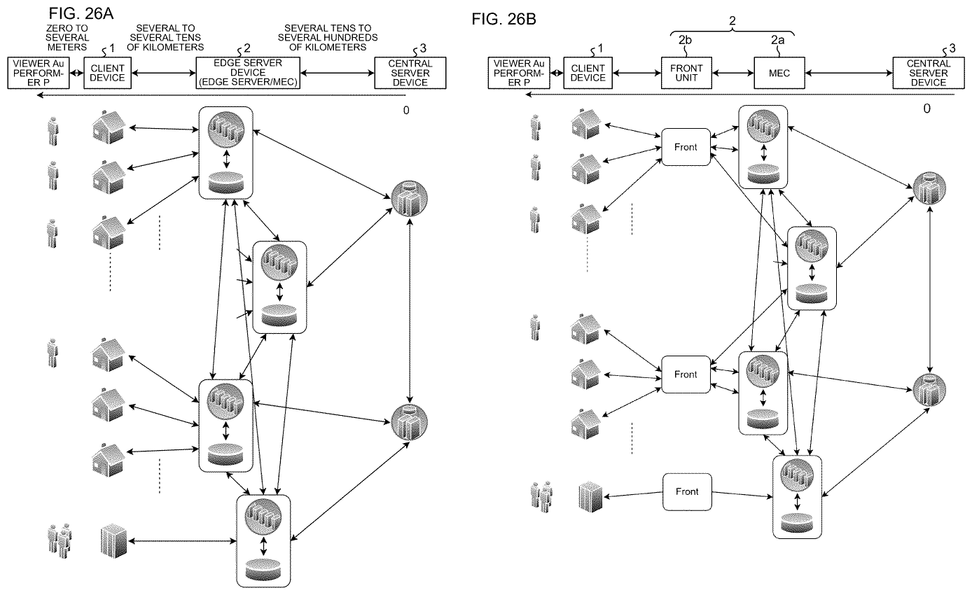

FIG. 25 is a diagram illustrating a consideration example. The problem (a) described above, i.e., the problem of data concentration on the 3D scene generation device is addressed. In the consideration example, a path is provided for sending 3D model data directly to a rendering device. While users (a viewer Au and a performer P) are expected to transmit the 3D model data to both the 3D scene generation device and the rendering device, contents of the data are devised to be changed. When distribution is started, second 3D model data (bounding box data) is transmitted from the performer P to the 3D scene generation device. On the other hand, animation data for moving a 3D model of the viewer Au is transmitted from the viewer Au to the 3D scene generation device. In this way, by not transmitting the data of the 3D model as it is to the 3D scene generation device, an input data rate to the 3D scene generation device is reduced. Basically, one or a few of the 3D scene generation devices are assumed to be in the system. Each rendering device is provided with a database device for storing the 3D model data.

For coping with the above-described problem (b), a plurality of the rendering devices is provided in the system, and rendering processing is performed on the basis of 3D scene description data necessary for rendering in each rendering device. It is not necessary to transmit 3D scene data including 3D models of all users. For example, as described in the above embodiment, a distribution target region is divided, and the rendering device is dispersedly arranged for each region. The rendering device performs data transmission with a viewer Au who lives near the rendering device. Alternatively, data is transmitted and received to and from a viewer Au participating from a facility in the region, such as a karaoke box or a live space provided with a capture device/3D model generation device. A motion-to-photon latency is reduced as the rendering device and the viewer Au are located at a physically close distance. Furthermore, in a viewer group corresponding to the same rendering device, a response delay in interaction between the 3D models of the viewers Au is reduced.

Based on the configuration of the above consideration example, a configuration in which the 3D model generation device of the viewer Au is separated from the capture device to form a motion data generation device, and the 3D model generation device of the performer P is separated from the capture device to form the 3D model generation device, is the data distribution system 100 according to the embodiment described above. Note that the configuration of the consideration example in FIG. 25 may also be one of the embodiments.

### 2. Modification

The disclosed technique is not limited to the above embodiments. Some modifications will be described.

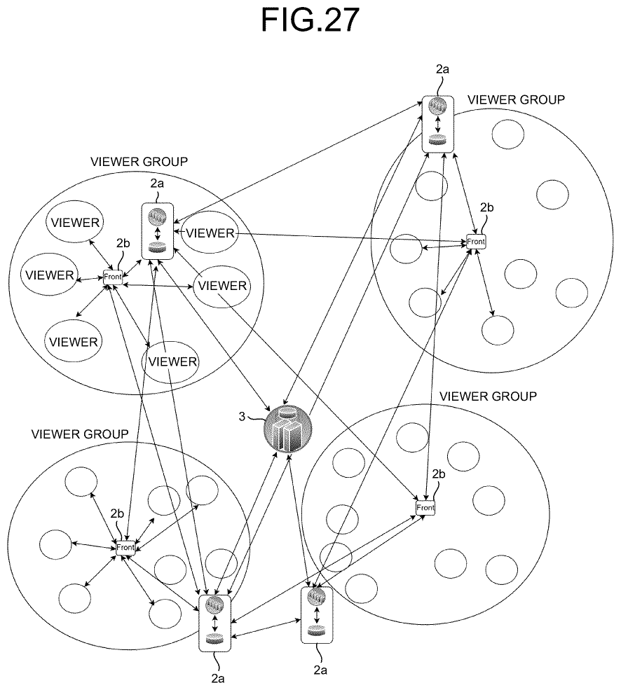

Regarding network resources, functions of an edge server device 2 may be separately (disassembled) arranged. Note that the edge server device 2 here may have a configuration including a corresponding database device 20. Description will be given with reference to FIG. 26.

FIG. 26 is a diagram illustrating an example of network resources. (A) of FIG. 26 illustrates the network resources in the embodiments described so far. The plurality of client devices 1 for use by the viewers Au or the performers P, the plurality of edge server devices 2 each corresponding to one or two or more client devices 1, and one or two or more central server devices 3 corresponding to the plurality of edge server devices 2 are arranged at physically separated positions. A distance between the devices is also exemplified.

It can be said that the edge server device 2 has both a function as a front server and a function as a MEC (calculation resources). In one embodiment, these functions may be arranged separately (disassembled). Such a modification is illustrated in (B) of FIG. 26.

In the modification illustrated in (B) of FIG. 26, each edge server device 2 includes a MEC 2a and a front unit 2b and is configured to have them disassembled, and have them separately arranged. The MEC 2a is a calculation resource necessary for various types of processing by the motion data generation device 21, the rendering device 22, the database device 20, and the like described so far. The MEC 2a functions as a front server, and, for example, performs data transmission with a corresponding client device 1 or allocates the MEC 2a to a corresponding user (to the client device 1 thereof). By dynamically performing this allocation according to a load condition of the MEC 2a or the like, the front unit 2b can serve as a load balancer.

It can be said that the edge server device 2 as described above has a configuration in which the resource allocation function that has been performed by the edge server device 2 is independent as the front unit 2b. This increases a degree of freedom of geographical arrangement of the MEC 2a. Description will be given with reference also to FIG. 27.

FIG. 27 is a diagram illustrating an example of a network configuration of the modification. A client device 1 (corresponding to “viewer” in FIG. 27) is connected to the nearest front unit 2b (front server). The front unit 2b is connected to a plurality of surrounding MEC 2a at a short distance. Each MEC 2a is connected to a central server device 3, and is further connected to a surrounding MEC 2a.

The front unit 2b and the MEC 2a may be arranged at the same base, or may be arranged, for example, at a distance of about several to several tens of kilometers. The MEC 2a may be arranged between the front units 2b. A distance of the MEC 2a may be, for example, about several kilometers to several tens of kilometers.

The MEC 2a may include a plurality of physical calculation resources, for example, a processor such as a CPU and a GPU. Alternatively, the MEC 2a may be realized by virtual calculation resources, for example, a plurality of virtualized calculation resources/instances (including GPU resources).

A dedicated calculation resource (physical or virtual) is allocated to each client device 1 at a ratio of 1:1. Due to the virtualization, it appears from the client device 1 that one calculation resource is allocated.

The allocation of the MEC 2a by the front unit 2b may include allocating the MEC 2a of other edge server device 2. For example, the front unit 2b of the edge server device 2 having the closest physical distance from the client device 1 of the viewer Au basically allocates the MEC 2a of the edge server device 2 to the viewer Au. However, in a case where there is no remaining calculation resource that can be allocated to the MEC 2a, the front unit 2b allocates the MEC 2a (of the edge server device 2) having the next closest geographical distance to the viewer Au. Searching a geographic distance as a priority can minimize possible communication delays.

Note that, for example, as described above, the 3D model data or the like of the corresponding viewer Au is transmitted to and stored in the database device 20 corresponding to the MEC 2a actually allocated to the viewer Au before distribution.

The client device 1 (i.e., the viewer Au or the performer P) is not aware of how much hardware is included in the virtual calculation resource allocated to the client device 1. Although in general, one CPU and one GPU provide calculation resources to a plurality of the client devices 1, the other way around, i.e., a plurality of CPU and a plurality of GPU may provide calculation resources to one client device 1.

The allocation of hardware to virtual calculation resources is decided by processing load estimation for each use case. There may be a case where the hardware allocation is dynamically changed over time.

### 3. Example of Hardware Configuration

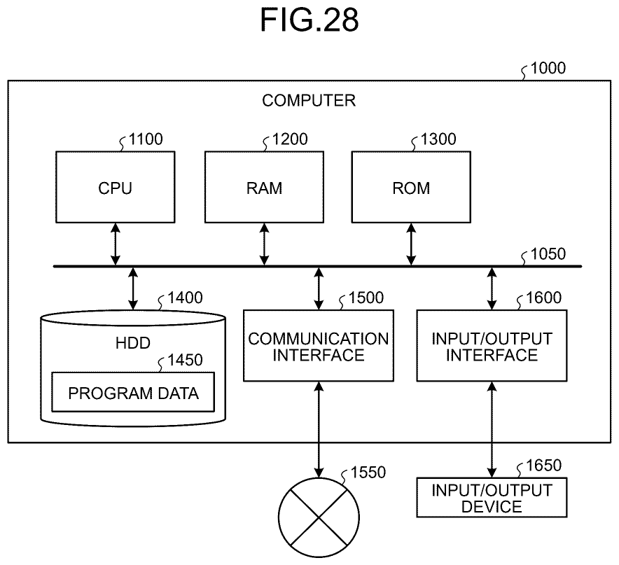

FIG. 28 is a diagram illustrating an example of a hardware configuration of a device. Each device (data processing device and the like) included in the data distribution system 100 described so far, specifically, the client device 1, the edge server device 2, the central server device 3, and each device included therein can be configured to include, for example, a computer 1000.

The computer 1000 includes a CPU 1100, a RAM 1200, a read only memory (ROM) 1300, a hard disk drive (HDD) 1400, a communication interface 1500, and an input/output interface 1600. Each unit of the computer 1000 is connected by a bus 1050.

The CPU 1100 operates on the basis of a program stored in the ROM 1300 or the HDD 1400, and controls each unit. For example, the CPU 1100 develops the program stored in the ROM 1300 or the HDD 1400 into the RAM 1200, and executes processing corresponding to various programs.

The ROM 1300 stores a boot program such as a basic input output system (BIOS) executed by the CPU 1100 when the computer 1000 is activated, a program depending on the hardware of the computer 1000, and the like.

The HDD 1400 is a computer-readable recording medium that non-transiently records a program executed by the CPU 1100, data for use by the program, and the like. Specifically, the HDD 1400 is a recording medium that records a program for executing each operation according to the present disclosure as an example of program data 1450.

The communication interface 1500 is an interface for the computer 1000 to connect to an external network 1550 (e.g., the Internet). For example, the CPU 1100 receives data from other apparatus or transmits data generated by the CPU 1100 to other apparatus via the communication interface 1500.

The input/output interface 1600 is configured to include the above-described I/F unit 18 and is an interface for connecting an input/output device 1650 and the computer 1000. For example, the CPU 1100 receives data from an input device such as a keyboard or a mouse via the input/output interface 1600. In addition, the CPU 1100 transmits data to an output device such as a display, a speaker, or a printer via the input/output interface 1600. In addition, the input/output interface 1600 may function as a media interface that reads a program or the like recorded in a predetermined recording medium (media). Examples of the medium include, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, and the like.

For example, in a case where the computer 1000 functions as the client device 1, the edge server device 2, or the central server device 3, the CPU 1100 of the computer 1000 executes a program loaded on the RAM 1200 to implement the function of the client device 1, the edge server device 2, or the central server device 3. In addition, a program and the like are stored in the HDD 1400. Note that although the CPU 1100 reads the program data 1450 from the HDD 1400 and executes the program data, as another example, the programs may be acquired from other device via the external network 1550.

### 4. Conclusion

The techniques described in the foregoing are specified as follows, for example. One of the disclosed techniques is the data distribution system 100. As has been described with reference to FIGS. 1 to 22, 26, 27, and the like, the data distribution system 100 includes the central server device 3 and the plurality of edge server devices 2 and 2-P. The central server device 3 (the 3D scene generation device 31) generates 3D scene description data that describes a scene in a virtual space that includes 3D models of a plurality of users (viewer Au, performer P) and changes in real time. Each (the rendering device 22, 22-P) of the plurality of edge server devices 2 and 2-P communicates with the central server device 3 and is dispersedly arranged at a position geographically separated from each other, and generates distribution data to a corresponding user on the basis of the 3D scene description data generated by the central server device 3.

According to the above-described data distribution system 100, since each of the plurality of edge server devices 2 and 2-P arranged in a dispersed manner generates distribution data to a corresponding user, a processing load is dispersed. In the central server device 3, it is not necessary to generate all data of a virtual space changing in real time, and it is enough to generate 3D scene description data describing a scene. A data transmission amount in the central server device 3 can be reduced accordingly. Therefore, it is possible to suppress a delay that may occur due to concentration of a processing load or an increase in a data transmission amount, for example, a motion-to-photon latency, a delay in interaction between the users in the virtual space, and the like.

As has been described with reference to FIG. 1 and the like, the 3D scene description data may be data including a description of arrangement of the plurality of users in the virtual space. For example, by using such 3D scene description data, it is possible to generate distribution data in the edge server devices 2 and 2-P while reducing the data transmission amount in the central server device 3.

As has been described with reference to FIGS. 1, 5, and the like, the edge server devices 2 and 2-P (the rendering device 22, the rendering device 22-P) may generate rendered video data of the virtual space as the distribution data on the basis of the 3D scene description data and 3D model data of the user. As a result, a processing load required for rendering can be dispersed, and the rendered video data can be distributed to the user. The data distribution system 100 can be used as a video distribution system.

As has been described with reference to FIGS. 1, 5, and the like, the edge server device 2 (the rendering device 22) may generate animation data of a 3D model of a corresponding user (viewer Au), and generate the video data on the basis of the generated animation data, the 3D scene description data, and the 3D model data (avatar data) of the user. For example, in this manner, video data including a 3D model of a moving user can be generated. Furthermore, a data transmission amount of animation data can be suppressed by an amount smaller than data indicating the 3D model data itself having movement.

As has been described with reference to FIG. 1 and the like, the animation data may include visual field/line-of-sight data of a corresponding user (viewer Au), and the edge server device 2 (the rendering device 22) may generate the video data when viewed from a viewpoint of the corresponding user (viewer Au). As a result, the video data suitable for distribution to the corresponding user can be generated.

As has been described with reference to FIGS. 1, 5, and the like, the edge server device 2 (the rendering device 22) may transmit generated animation data to the central server device 3 (the 3D scene generation device 31), and the central server device 3 may generate the 3D scene description data on the basis of animation data from the edge server device 2. The animation data having a small data amount is thus transmitted from the edge server device 2 to the central server device 3, and the 3D scene description data is generated by the central server device 3, so that the data transmission amount can be suppressed.

As has been described with reference to FIGS. 1, 2, 5, and the like, the data distribution system 100 may further include the client device 1-P (the 3D model generation device 13) that communicates with the edge server devices 2 and 2-P and the central server device 3 and generates 3D model data of a corresponding user (performer P). 3D model data generated by the client device 1-P (the 3D model generation device 13) may include first 3D model data including at least one of point cloud data, mesh data, and texture data, and second 3D model data including bounding box data. The client device 1-P (the 3D model generation device 13) may transmit the first 3D model data among the generated 3D model data to the edge server devices 2 and 2-P (the rendering device 22, the rendering device 22-P), and transmit the second 3D model data to the central server device 3 (the 3D scene generation device 31). The edge server devices 2 and 2-P (the rendering device 22, the rendering device 22-P) may generate the video data on the basis of the first 3D model data, and the central server device 3 (the 3D scene generation device 31) may generate the 3D scene description data on the basis of the second 3D model data. Only the second 3D model data having a small data amount is thus transmitted to the central server device 3 to generate the 3D scene description data there, whereby the data transmission amount can be suppressed.

As has been described with reference to FIGS. 26 and 27, and the like, each of the plurality of edge server devices 2 may include the MEC 2a as a calculation resource and the front unit 2b that allocates the MEC 2a to a corresponding user (viewer Au), and the allocation by the front unit 2b may include allocating the MEC 2a of other edge server device 2. As a result, the degree of freedom of the geographical arrangement of the MEC 2a can be increased.

As has been described with reference to FIG. 1 and the like, the virtual space may include a virtualized live event venue, and the plurality of users may include a plurality of viewers Au and one or more performers P. For example, such a live event can be delivered with a short delay.

As has been described with reference to FIG. 1 and the like, the communication may be optical communication (the network N may be an all photonics communication network). This increases a possibility of further suppressing a delay.

As has been described with reference to FIG. 1 and the like, the distribution data may include video data and sound data. Even in a case where such data having a large data amount is distributed, a delay can be suppressed.

The data distribution method described with reference to FIGS. 1 to 22, 26, 27, and the like is also one of the disclosed techniques. A data distribution method includes: generating, by the central server device 3 (the 3D scene generation device 31), 3D scene description data that describes a scene in a virtual space that includes 3D models of a plurality of users (viewer Au, performer P) and changes in real time (Step S31, Step S41); and generating, by each of the plurality of edge server devices 2 and 2-P, distribution data to a corresponding user on the basis of the 3D scene description data generated by the central server device 3, each of the plurality of edge server devices communicating with the central server device 3 and being dispersedly arranged at a position geographically separated from each other (Step S34, Step S43). Also by such a data distribution method, a delay can be suppressed as described so far.

The data processing devices constituting the data distribution system 100, for example, the edge server devices 2 and 2-P, and the data processing method using such data processing devices are also techniques disclosed. As has been described with reference to FIGS. 1 to 22, 26, 27, and the like, the edge server devices 2 and 2-P generate distribution data to a corresponding user on the basis of 3D scene description data that describes a scene in a virtual space that includes 3D models of a plurality of users (viewer Au, performer P) and changes in real time. The data processing method includes generating, by the edge server devices 2 and 2-P, distribution data to a corresponding user on the basis of 3D scene description data that describes a scene in a virtual space that includes 3D models of a plurality of users and changes in real time (Step S34, Step S43). Also by such a data processing device or a data processing method, a delay can be suppressed as described so far.

Note that the effects described in the present disclosure are merely examples and are not limited to the disclosed contents. There may be other effects.

Although the embodiments of the present disclosure have been described in the foregoing, the technical scope of the present disclosure is not limited to the above-described embodiments as they are, and various modifications can be made without departing from the gist of the present disclosure. In addition, components of different embodiments and modifications may be appropriately combined.

The disclosed technique can also be described as follows. For example, the data distribution system 100 may be a video/music distribution system. In order to realize a virtual space reflecting movement of the viewer Au or the performer P in a real space, the 3D scene generation device 31 may be arranged in one or a few central data centers (the central area R3, the central server device 3), and the rendering devices 22 and 22-P may be dispersedly arranged in a regional data center (the regional area R2, the edge server devices 2 and 2-P) existing in each region where the video/music content is provided.

The regional data center may be connected to the central data center or other regional data center via the network N.

The 3D scene generation device 31 may generate 3D scene description data for designing/controlling a video/music content in the virtual space.

The rendering devices 22 and 22-P may generate video/audio (video/sound) viewed by the viewer Au or the performer P by rendering processing according to the visual field/line-of-sight data of the viewer Au or the performer P on the basis of the 3D scene description data.

Basically, real-time movement data of the viewer Au and the performer P may be received by a regional data center whose geographical distance is the shortest. In addition, basically, the viewer Au and the performer P may receive rendering video (rendered video) from the regional data center having the shortest geographical distance.

Movement data reflecting movement of the viewer Au in the real space on the virtual space may include avatar data (3D model data) of the viewer Au and animation data for the avatar data.

The movement of the viewer Au in the real space may be reflected in the virtual space by transmitting animation data for the avatar data of the viewer Au to the 3D scene generation device 31.

Movement data reflecting movement of the performer P in the real space in the virtual space may include 3D model data that captures the movement of the performer P from moment to moment and changes in time series.

The movement of the performer P in the real space may be reflected in the virtual space by transmitting bounding box data related to the 3D model data of the performer to the 3D scene generation device 31.

Between the client devices 1 or the viewers Au belonging to a viewer group which is a set of clients (the client devices or the viewers Au using the client devices 1) using a common regional data center, it may be guaranteed that interaction is possible within a certain delay time calculated in advance.

The motion data generation device 21 that generates animation data (motion data) for moving the avatar of the viewer Au may transmit the animation data to the rendering device 22 in the regional data center and to the central data center.

The rendering device 22 that generates video/music data for the viewer Au may generate a rendering image by combining latest animation data of the viewer Au from the motion data generation device 21 with the 3D scene description data received from the central data center in order to reflect the real-time movement of the viewer Au in the rendering image with a short delay.

In order to reflect the movement of the performer P in a 3D scene at a low data rate, the 3D model generation device 13 may transmit real-time bounding box data of the performer P to a central data center in which the 3D scene generation device 31 is located.

The rendering device 22-P that generates video/music data for the performer P may generate a rendering image by combining latest 3D data of the performer P from the 3D model generation device 13 with the 3D scene description data received from the central data center in order to reflect the real-time movement of the performer P in the rendering image with a short delay.

According to the techniques described so far, for example, in order to solve a problem in realizing large-scale interactive music live show distribution on an all photonics network, a system configuration is devised, and association to physical network resources is defined. This allows for reduced data rates on the network, a reduced latency, and participation of a larger number of viewers as compared with a conventional simple server-client configuration.

The 3D scene generation device 31 is arranged in a central data center that controls the entire music live show, and the rendering devices 22 and 22-P are dispersedly arranged in data centers (regional data centers) of respective regions. The viewer AU and the performer P transmit sensing data (capture data) from the capture devices 11 and 11-P or 3D model data generated on-premises to a regional data center at a close physical distance. In addition, a rendered video is received from the regional data center at a close physical distance. This enables reduction of a motion-to-photon latency of the viewer. It is possible to reduce a response delay at the time of interaction between viewers Au using the same regional data center. A rendering processing load of the rendering devices 22 and 22-P can be dispersed. Outputs of rendering images from the rendering devices 22 and 22-P can be dispersed.

In order to reflect movement of the viewer Au in a 3D scene, the regional data center transmits animation data (motion data) for moving an avatar of the viewer Au to the central data center as real-time 3D model data. As a result, a rate of input data related to the viewer Au to the central data center is reduced.

The regional data center combines 3D scene description data received from the central data center with newer animation data from the motion data generation device 21 to construct a 3D scene. A motion-to-photon latency of the viewer Au can be reduced.

In order to reflect movement of the performer P in a 3D scene, the regional data center sends bounding box data of the performer P to the central data center as real-time 3D model data. As a result, a rate of input data related to the performer P to the central data center is reduced.

The regional data center combines the 3D scene description data received from the central data center with newer 3D model data from the 3D model generation device 13 to construct a 3D scene. This enables reduction of a motion-to-photon latency of the performer P.

Note that the present techniques can also have the following configurations.
(1) A data distribution system comprising:
   a central server device that generates 3D scene description data that describes a scene in a virtual space that includes 3D models of a plurality of users and changes in real time; and
   a plurality of edge server devices each communicating with the central server device and being dispersedly arranged at a position geographically separated from each other, and generating distribution data to a corresponding user on the basis of the 3D scene description data generated by the central server device.
(2) The data distribution system according to (1), wherein
   the 3D scene description data is data including a description of arrangement of the 3D models of the plurality of users in the virtual space.
(3) The data distribution system according to (1) or (2), wherein
   the edge server device generates rendered video data of the virtual space as the distribution data on the basis of the 3D scene description data and 3D model data of the user.
(4) The data distribution system according to (3), wherein
   the edge server device generates animation data of a 3D model of a corresponding user, and generates the video data on the basis of the generated animation data, the 3D scene description data, and the 3D model data of the user.
(5) The data distribution system according to (4), wherein
   the animation data includes visual field/line-of-sight data of a corresponding user, and
   the edge server device generates the video data when viewed from a viewpoint of the corresponding user.
(6) The data distribution system according to (4) or (5), wherein
   the edge server device transmits generated animation data to the central server device, and
   the central server device generates the 3D scene description data on the basis of animation data from the edge server device.
(7) The data distribution system according to any one of (3) to (6), further comprising:
   a client device that communicates with the edge server device and the central server device and generates 3D model data of a corresponding user, wherein
   3D model data generated by the client device includes:
   first 3D model data including at least one of mesh data, texture data, and point cloud data; and
   second 3D model data including bounding box data,
   the client device transmits the first 3D model data among the generated 3D model data to the edge server device, and transmits the second 3D model data to the central server device,
   the edge server device generates the video data on the basis of the first 3D model data, and
   the central server device generates the 3D scene description data on the basis of the second 3D model data.
(8) The data distribution system according to any one of (1) to (7), wherein
   each of the plurality of edge server devices includes:
   a MEC as a calculation resource; and
   a front unit that allocates the MEC to a corresponding user, and
   the allocation by the front unit includes allocating a MEC of other edge server device.
(9) The data distribution system according to any one of (1) to (8), wherein
   the virtual space includes a virtualized live event venue, and
   the plurality of users includes a plurality of viewers and one or more performers.
(10) The data distribution system according to any one of (1) to (9), wherein
   the communication is optical communication.
(11) The data distribution system according to any one of (1) to (10), wherein
   the distribution data includes video data and sound data.
(12) A data distribution method comprising:
   generating, by a central server device, 3D scene description data that describes a scene in a virtual space that includes 3D models of a plurality of users and changes in real time; and
   generating, by each of a plurality of edge server devices, distribution data to a corresponding user on the basis of the 3D scene description data generated by the central server device, each of the plurality of edge server devices communicating with the central server device and being dispersedly arranged at a position geographically separated from each other.
(13) A data processing device
   that generates distribution data to a corresponding user on the basis of 3D scene description data that describes a scene in a virtual space that includes 3D models of a plurality of users and changes in real time.
(14) A data processing method comprising:
   generating, by a data processing device, distribution data to a corresponding user on the basis of 3D scene description data that describes a scene in a virtual space that includes 3D models of a plurality of users and changes in real time.

### REFERENCE SIGNS LIST

100 DATA DISTRIBUTION SYSTEM
1 CLIENT DEVICE
11 CAPTURE DEVICE
12 DISPLAY DEVICE
1-P CLIENT DEVICE
11-P CAPTURE DEVICE
12-P DISPLAY DEVICE
13 3D MODEL GENERATION DEVICE
2 EDGE SERVER DEVICE (DATA PROCESSING DEVICE)
20 DATABASE DEVICE
21 MOTION DATA GENERATION DEVICE
22 RENDERING DEVICE
2-P EDGE SERVER DEVICE (DATA PROCESSING DEVICE)
20-P DATABASE DEVICE
22-P RENDERING DEVICE
2a MEC
2b FRONT UNIT
3 CENTRAL SERVER DEVICE (DATA PROCESSING DEVICE)
30 DATABASE DEVICE
31 3D SCENE GENERATION DEVICE (DATA PROCESSING DEVICE)
Au VIEWER (USER)
N NETWORK
P PERFORMER (USER)
R1 ON-PREMISES AREA
R2 REGIONAL AREA
R3 CENTRAL AREA

1. A data distribution system comprising:
a central server device that generates 3D scene description data that describes a scene in a virtual space that includes 3D models of a plurality of users and changes in real time; and
a plurality of edge server devices each communicating with the central server device and being dispersedly arranged at a position geographically separated from each other, and generating distribution data to a corresponding user on the basis of the 3D scene description data generated by the central server device.

2. The data distribution system according to claim 1, wherein
the 3D scene description data is data including a description of arrangement of the 3D models of the plurality of users in the virtual space.

3. The data distribution system according to claim 1, wherein
the edge server device generates rendered video data of the virtual space as the distribution data on the basis of the 3D scene description data and 3D model data of the user.

4. The data distribution system according to claim 3, wherein
the edge server device generates animation data of a 3D model of a corresponding user, and generates the video data on the basis of the generated animation data, the 3D scene description data, and the 3D model data of the user.

5. The data distribution system according to claim 4, wherein
the animation data includes visual field/line-of-sight data of a corresponding user, and
the edge server device generates the video data when viewed from a viewpoint of the corresponding user.

6. The data distribution system according to claim 4, wherein
the edge server device transmits generated animation data to the central server device, and
the central server device generates the 3D scene description data on the basis of animation data from the edge server device.

7. The data distribution system according to claim 3, further comprising:
a client device that communicates with the edge server device and the central server device and generates 3D model data of a corresponding user, wherein
3D model data generated by the client device includes:
first 3D model data including at least one of mesh data, texture data, and point cloud data; and
second 3D model data including bounding box data,
the client device transmits the first 3D model data among the generated 3D model data to the edge server device, and transmits the second 3D model data to the central server device,
the edge server device generates the video data on the basis of the first 3D model data, and
the central server device generates the 3D scene description data on the basis of the second 3D model data.

8. The data distribution system according to claim 1, wherein
each of the plurality of edge server devices includes:
a MEC as a calculation resource; and
a front unit that allocates the MEC to a corresponding user, and
the allocation by the front unit includes allocating a MEC of other edge server device.

9. The data distribution system according to claim 1, wherein
the virtual space includes a virtualized live event venue, and
the plurality of users includes a plurality of viewers and one or more performers.

10. The data distribution system according to claim 1, wherein
the communication is optical communication.

11. The data distribution system according to claim 1, wherein
the distribution data includes video data and sound data.

12. A data distribution method comprising:
generating, by a central server device, 3D scene description data that describes a scene in a virtual space that includes 3D models of a plurality of users and changes in real time; and
generating, by each of a plurality of edge server devices, distribution data to a corresponding user on the basis of the 3D scene description data generated by the central server device, each of the plurality of edge server devices communicating with the central server device and being dispersedly arranged at a position geographically separated from each other.

13. A data processing device
that generates distribution data to a corresponding user on the basis of 3D scene description data that describes a scene in a virtual space that includes 3D models of a plurality of users and changes in real time.

14. A data processing method comprising:
generating, by a data processing device, distribution data to a corresponding user on the basis of 3D scene description data that describes a scene in a virtual space that includes 3D models of a plurality of users and changes in real time.
